(19) United States
(12) Patent Application Publication
(10) Pub. No.: US 2012/0240798 A1
(43) Pub. Date: Sep. 27, 2012

(54) RESIN COMPOSITION FOR LASER ENGRAVING, FLEXO PRINTING PLATE PRECURSOR FOR LASER ENGRAVING AND PROCESS FOR PRODUCING SAME, AND FLEXO PRINTING PLATE AND PROCESS FOR MAKING SAME

(75) Inventor: Yuusuke KOZAWA, Haibara-gun (JP)

(73) Assignee: FUJIFILM CORPORATION, Tokyo (JP)

(21) Appl. No.: 13/427,536

(22) Filed: Mar. 22, 2012

(30) Foreign Application Priority Data
Mar. 23, 2011 (JP) 2011-064835

(51) Int. Cl. B41N 1/06; B29C 35/08; C08L 25/10; C08K 3/04; B32B 3/30; C08L 29/04

(52) U.S. Cl. 101/395; 428/220; 524/503; 524/522; 525/57; 521/54; 524/523; 525/61; 525/221; 525/227; 264/400

(57) ABSTRACT

Disclosed are a resin composition, a flexo printing plate precursor, a process for producing a flexo printing plate precursor, a process for making a flexo printing plate, and a flexo printing plate having a relief layer produced by the process for making a flexo printing plate. The resin composition comprises 1 to 25 wt % of colorless resin particles having a volume-average particle diameter of 0.2 to 30 μm, 1 to 15 wt % of a photothermal conversion agent capable of absorbing light having a wavelength of 700 to 1,300 nm, and 2 to 95 wt % of a binder polymer, in which the 20% weight-reduction temperature of the colorless resin particles in thermogravimetric analysis under an inert gas atmosphere is from 200 to 600° C.

### BACKGROUND OF THE INVENTION

1. Field of the Invention

The present invention relates to a resin composition for laser engraving, a flexo printing plate precursor for laser engraving and a process for producing the same, and a flexo printing plate and a process for making the same.

2. Description of Related Art

There have been proposed a number of so-called “direct engraving CTP systems”, in which relief-forming layers are subjected to direct engraving with a laser to make a printing plate. In these systems, a laser is directly irradiated on a flexo plate precursor to cause thermal decomposition and volatilization by photothermal conversion, thereby forming a concave portion. The direct engraving CTP system can control the relief shape freely unlike the formation of relief using an original film. For this reason, for example, in a case where an image such as outline characters is formed, the region can be more deeply engraved than other regions. Alternatively, in minute halftone dot images, taking into consideration resistivity against printing pressure, engraving to form shoulders can be conducted. As a laser used in this system, a high output power carbon dioxide laser is generally used. In the case of the carbon dioxide laser, all organic compounds can absorb irradiation energy, and thus the absorbed irradiation energy can be converted into heat. On the other hand, there have been developed inexpensive small semiconductor lasers, but since they irradiate visible and near infrared light, it is necessary to absorb the laser light and convert it into heat.

In this regard, in JP-A-2009-241497, a relief-forming resin composition, to which is added an additive having excellent thermal conductivity and has increased engraving sensitivity by virtue of the heat transfer efficiency of the relief-forming layer, has been known.

In addition, a relief-forming resin composition, in which carbon black is mixed in order to form a relief with enhanced mechanical and physical properties, has been disclosed in Japanese Registered Patent No. 2846954 and Japanese Registered Patent No. 2846955.

On the other hand, a relief-forming resin composition including organic fine particles having excellent heat resistance from the viewpoint of improved productivity of a flexo printing plate precursor for laser engraving has been known in JP-A-2010-162733.

### SUMMARY OF THE INVENTION

In the case of promoting enhancement of the mechanical and physical properties of a relief-forming layer by mixing carbon black in a flexo printing plate precursor for laser engraving, there is a problem that mixing of carbon black sacrifices the light beam-transmitting properties of the relief-forming layer, and thus, laser light does not reach the depths thereof. In the case of a flexo printing plate precursor for laser engraving, not only is there a possibility that the engraving sensitivity is reduced, but it also becomes difficult to promote the photochemical enhancement of the relief-forming layer. Therefore, when performing laser engraving, a large amount of residue (including a viscous liquid) which is hard to remove is generated, and as a result, there occurs a problem that a lot of time is required for treatment of a plate after engraving and for removal of engraving residue accumulated in the pipe section extending from an engraving machine to an engraving residue dust-collecting machine.

By using organic fine particles having excellent heat resistance, the engraving residue is prevented from being thickened, and improvement of rinsing properties is promoted. However, with the use of the organic fine particles having excellent heat resistance, the engraving sensitivity is lowered, which may lead to decrease in productivity.

It is an object of the present invention to provide a resin composition for laser engraving that can be used to make an excellent printing plate precursor having high engraving sensitivity as well as excellent rinsing properties and dust-collecting properties; a flexo printing plate precursor for laser engraving using the resin composition and a process for producing the same; a process for making a flexo printing plate using the printing plate precursor; and a flexo printing plate.

The above-described objects of the present invention have been accomplished by the means described in <1>, <11>, <14>, <15>, and <18> below. Preferred embodiments, <2> to <10>, <12>, <13>, <16>, and <17> are also described below therewith.

<1> A resin composition comprising 1 to 25 wt % of (Component A) colorless resin particles having a volume-average particle diameter of 0.2 to 30 μm; 1 to 15 wt % of (Component B) a photothermal conversion agent capable of absorbing light having a wavelength of 700 to 1,300 nm; and 2 to 95 wt % of (Component C) a binder polymer, wherein the 20% weight-reduction temperature of Component A in thermogravimetric analysis under an inert gas atmosphere is from 200 to 600° C.

<2> The resin composition according to <1>, wherein the volume-average particle diameter of Component B is from 0.001 μm to 10 μm.

<3> The resin composition according to <1>, wherein Component B is carbon black.

<4> The resin composition according to <1>, wherein Component A is at least one type of colorless resin particles selected from the group consisting of methyl polymethacrylate particles, porous polyacrylic acid ester particles, dimethyl polysiloxane particles, polyimide particles, and ethylene-vinyl acetate copolymer particles.

<5> The resin composition according to <1>, wherein Component A is at least one type of colorless resin particles selected from the group consisting of methyl polymethacrylate particles, porous polyacrylic acid ester particles, and dimethyl polysiloxane particles.

<6> The resin composition according to <1>, wherein the resin composition further comprises (Component D) a polymerizable compound.

<7> The resin composition according to <6>, wherein the polymerizable compound has two or more ethylenically unsaturated bonds.

<8> The resin composition according to <1>, wherein the resin composition further comprises (Component E) a compound having at least one of a hydrolyzable silyl group and/or silanol groups.

<9> The resin composition according to <1>, wherein the resin composition further comprises (Component F) an alcohol exchange reaction catalyst.

<10> The resin composition according to <1>, wherein the 20% weight-reduction temperature of Component A in thermogravimetric analysis under an inert gas atmosphere is from 300 to 400° C.

<11> A flexo printing plate precursor having a relief-forming layer formed with the resin composition according to <1>.

<12> A flexo printing plate precursor having a crosslinked relief-forming layer formed by crosslinking the relief-forming layer formed with the resin composition according to <1> by light and/or heat.

<13> The flexo printing plate precursor according to <11>, wherein the thickness of the relief-forming layer is 0.05 mm or more and 10 mm or less.

<14> A process for producing a flexo printing plate precursor, comprising a layer forming step of forming a relief-forming layer comprising the resin composition according to <1>; and a crosslinking step of crosslinking the relief-forming layer by heat and/or light to obtain a flexo printing plate precursor having a crosslinked relief-forming layer.

<15> A process for making a flexo printing plate, comprising an engraving step of subjecting the flexo printing plate precursor having a crosslinked relief-forming layer according to <12> to laser engraving to form a relief layer.

<16> The process for making a flexo printing plate according to <15>, wherein the laser engraving is carried out by means of a semiconductor laser.

<17> The process for making a flexo printing plate according to <15>, further comprising a washing step of washing the surface of the relief layer after the engraving step with water or an aqueous solution.

<18> A flexo printing plate having a relief layer produced by the process for making a flexo printing plate according to <15>.

### DETAILED DESCRIPTION OF THE INVENTION

The present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Furthermore, ‘(Component A) colorless resin particles’ etc. are simply called ‘Component A’ etc.

### (Resin Composition for Laser Engraving)

The resin composition for laser engraving of the present invention (hereinafter, also called a ‘resin composition’) comprises (Component A) colorless resin particles, (Component B) a photothermal conversion agent, and (Component C) a binder polymer.

The resin composition of the present invention may be used without any particular limitation in a wide range of other applications in addition to a relief-forming layer of a flexo printing plate precursor that is subjected to laser engraving. For example, it may be used not only in formation of a relief-forming layer of a printing plate precursor for which formation of a raised relief is carried out by laser engraving, which is described in detail later, but also in formation of another material form in which asperities or apertures are formed on the surface, for example, various types of printing plates or various types of moldings in which an image is formed by laser engraving, such as an intaglio plate, a stencil plate, or a stamp.

Among them, a preferred embodiment is use in formation of a relief-forming layer provided on an appropriate support.

The operation mechanism in the present invention is not clear, but is presumed to be as follows.

The photothermal conversion agent used in the present invention generates heat by irradiation of laser light, and the surplus heat generated assists in the thermal decomposition of the coexisting binder polymer. It is thought that the photothermal conversion agent also acts as a filler and contributes to enhancement of the mechanical and physical properties. However, when the content of the photothermal conversion agent is significantly increased by focusing on enhancement of the mechanical and physical properties or the rinsing properties, the engraving sensitivity decreases. It is thought that this decrease is caused by significant decrease in light beam-transmitting properties, and thus the laser light no longer reaches inside the printing plate precursor. In the present invention, by adding the colorless resin particles in combination with the photothermal conversion agent, enhancement of the mechanical and physical properties and improvement of the rinsing properties due to the addition of the colorless resin particles are promoted, and therefore, the content of the photothermal conversion agent can be controlled to an appropriate amount. Further, it was found that by adding the photothermal conversion agent and the colorless resin particles at the same time, the dust-collecting properties of the engraving residue (ease of the removal of engraving residue accumulated in the pipe section extending from the engraving machine to the engraving residue dust-collecting machine) were increased. The reason is presumed to be that the difference in the surface energy of the photothermal conversion agent and the colorless resin particles causes the photothermal conversion agent to gather in the proximity of the colorless resin particles and leads to a specific compositional distribution of the engraving residue, the reason for which is not clear. As described above, by adding the photothermal conversion agent and the colorless resin particles at the same time, the laser light can penetrate efficiently inside the printing plate precursor during the laser engraving, and a flexo printing plate precursor for laser engraving, which has excellent engraving sensitivity, rinsing properties, and dust-collecting properties, can be made.

In the present specification, when a flexo printing plate precursor is explained, a layer that serves as an image-forming layer subjected to laser engraving, that has a flat surface, and that is an uncrosslinked crosslinkable layer is called a relief-forming layer, a layer that is formed by crosslinking the relief-forming layer is called a crosslinked relief-forming layer, and a layer that has asperities formed on the surface by laser engraving the crosslinked relief-forming layer is called a relief layer.

Constituent components of the resin composition for laser engraving are explained below.

### (Component A) Colorless Resin Particles

(Component A) colorless resin particles used in the present invention are described below.

In the present invention, the term colorless with respect to the colorless resin particles refers to an optical absorption property having no maximum absorption wavelength in the visible light region ranging from 400 to 700 nm, and the colorless resin particles refer to resin particles including a resin having the above optical absorption property. The colorless resin particles do not contain a colorant such as a dye and a pigment.

The absorption wavelength is measured with, for example, an ultraviolet-visible spectrophotometer V-7100 manufactured by JASCO Corporation.

Component A preferably contains spherical particles in terms of the shape of the particles in a proportion of 40% or more, more preferably 60% or more, and particularly preferably 70% or more.

When Component A contains the spherical particles in a proportion of 40% or more, the durability of the flexo printing plate precursor for laser engraving and the flexo printing plate using the same of the present invention can be improved. Further, the meaning of ‘spherical shape’ with respect to the spherical particles is not limited to an absolute spherical shape, but includes a substantially spherical shape.

The shape of Component A can be observed by means of a scanning electron microscope, and it is desirable to observe the particles at a magnification such that about 50 particles are captured in the monitor screen of the microscope. The evaluation criteria for the sphericity are with aspect ratios of the particles of interest in the range of 1.0 to 2.2.

Component A is particles having a volume-average particle diameter of 0.2 to 30 μm, preferably 0.3 to 20 μm, and more preferably 0.5 to 10 μm.

The volume-average particle diameter of Component A can be measured using a laser scattering particle diameter distribution measuring apparatus.

The 20% weight-reduction temperature of Component A in thermogravimetric analysis conducted in an inert gas atmosphere is from 200 to 600° C., preferably from 250 to 500° C., and more preferably from 300 to 400° C.

In the thermogravimetric analysis of Component A, while flowing an inert gas, for example, nitrogen gas, the weight reduction rate is measured using a thermogravimetric measuring apparatus (manufactured by TA Instruments Japan Co., Ltd.) under temperature elevation at a predetermined rate of 5° C./minute.

In addition, Component A may also be a porous body. By providing Component A in the form of a porous body, the engraving residue that is liquefied in laser engraving can be effectively removed.

The specific surface area of Component A having porosity is preferably from 1 to 1,000 m²/g, more preferably from 50 to 700 m²/g, and particularly preferably from 100 to 500 m²/g.

The pore volume of the colorless resin particles (A) having porosity is preferably from 0.1 to 10 mL/g, and more preferably from 0.1 to 5 mL/g.

The pore diameter of Component A having porosity is preferably from 1 to 1,000 nm, more preferably from 2 to 200 nm, and particularly preferably from 2 to 50 nm.

The above-mentioned specific surface area, pore volume, and pore diameter can be determined by known methods, and for example, nitrogen adsorption isotherm at −196° C.

The material of Component A is not particularly limited as long as it is a resin that satisfies the preferred embodiment in terms of the thermogravimetric properties as described above and the colorless properties, the shape, the size, or the like, as described above, but examples thereof preferably include resins such as a siloxane-based resin, a styrene-based resin, a (meth)acryl-based resin, a styrene-acryl copolymer, an ethylene-vinyl acetate copolymer, a methyl polymethacrylate, a porous polyacrylic acid ester, a dimethyl polysiloxane, a polyimide, a polyurethane, and a polyethylene, and more preferably include a methyl polymethacrylate, a porous polyacrylic acid ester, a dimethyl polysiloxane, a polyimide, and an ethylene-vinyl acetate copolymer. That is, Component A is more preferably at least one type of colorless resin particles selected from the group consisting of methyl polymethacrylate particles, porous polyacrylic acid ester particles, dimethyl polysiloxane particles, polyimide particles, and ethylene-vinyl acetate copolymer particles.

In addition, with respect to particles having a void in particles such as hollow organic particles, since the engraved shape becomes unstable, it is preferable that these particles are not included in the flexo printing plate precursor for laser engraving of the present invention.

The content of Component A is preferably from 1 to 25 wt %, more preferably from 1 to 15 wt %, and particularly preferably from 1.5 to 8 wt %, based on the total solid content excluding the volatile components of the resin composition for laser engraving. By setting the content of Component A within the above-described ranges, an effect of increasing the viscosity of the liquid engraving residue generated in a large amount during laser engraving can be certainly demonstrated.

(Component A) colorless resin particles can have an effect of increasing the viscosity of the liquid engraving residue generated while the flexo printing plate precursor for laser engraving is subjected to laser engraving, and is thus thought to contribute to solidification of the engraving residue. Further, Component A tends to be decomposed or melted by heat of laser engraving, and is advantageous in that it does not remain in the form of particles on the laser engraving surface like inorganic particles.

Furthermore, when Component A is used in combination with (Component B) a photothermal conversion agent, the dust-collecting properties of the engraving residue are improved and also the laser light can be efficiently penetrated into the inside of the relief-forming layer during engraving, and thus, it is thought that the engraving sensitivity can be increased.

### (Component B) Photothermal Conversion Agent

(Component B) a photothermal conversion agent can absorb light at a wavelength in a range of 700 to 1,300 nm. In the case of using a laser emitting infrared rays in the wavelength region of 700 to 1,300 nm (YAG laser, semiconductor laser, fiber laser, surface-emitting laser, or the like) in the flexo printing plate precursor for laser engraving of the present invention as a light source in the laser engraving, Component B is used as an infrared absorber. Component B absorbs the laser light to generate heat and promote the thermal decomposition of the precursor relief layer of the printing plate precursor, and is thus thought to improve the sensitivity in the laser engraving of the flexo printing plate precursor for laser engraving of the present invention.

Component B is not particularly limited as long as it absorbs light at a wavelength of 700 to 1,300 nm as a specific compound, but preferable examples thereof include a dye and a pigment.

As the dye, commercially available dyes and known dyes described in literature, for example, “Senryo Binran (Dye Handbook)” (compiled by The Society of Synthetic Organic Chemistry, Japan, 1970) can be used.

Specifically, examples thereof include those having a maximum absorption wavelength at 700 to 1,300 nm, and include dyes such as an azo dye, a metal complex azo dye, a pyrazolone azo dye, a naphthoquinone dye, an anthraquinone dye, a phthalocyanine dye, a carbonium dye, a diimmonium compound, a quinoneimine dye, a methine dye, a cyanine dye, a squarylium dye, a pyrylium salt, and a metal thiolate complex.

Preferable examples of the dyes include cyanine dyes disclosed in JP-A-58-125246, JP-A-59-84356, JP-A-59-202829, JP-A-60-78787 and the like; methine dyes disclosed in JP-A-58-173696, JP-A-58-181690, JP-A-58-194595 and the like; naphthoquinone dyes disclosed in JP-A-58-112793, JP-A-58-224793, JP-A-59-48187, JP-A-59-73996, JP-A-60-52940, JP-A-60-63744 and the like; squarylium dyes disclosed in JP-A-58-112792; and cyanine dyes disclosed in U.K. Patent No. 434,875 and the like.

Furthermore, near infrared ray absorption sensitizers disclosed in U.S. Pat. No. 5,156,938 may also be suitably used, and substituted arylbenzo(thio)pyrylium salts disclosed in U.S. Pat. No. 3,881,924, trimethine thiapyrylium salts disclosed in JP-A-57-142645 (U.S. Pat. No. 4,327,169), pyrylium type compounds disclosed in JP-A-58-181051, JP-A-58-220143, JP-A-59-41363, JP-A-59-84248, JP-A-59-84249, JP-A-59-146063 and JP-A-59-146061, cyanine dyes disclosed in JP-A-59-216146, pentamethine thiopyrylium salts disclosed in U.S. Pat. No. 4,283,475, and pyrylium salts disclosed in JP-B-5-13514 and JP-B-5-19702 are preferably used. Other preferable examples of the dyes include near infrared ray absorption dyes represented by Formula (I) or (II) described in U.S. Pat. No. 4,756,993.

Furthermore, other preferable examples of Component B of the present invention include specific indolenine cyanine dyes disclosed in JP-A-2002-278057.

Among these dyes, preferable examples include cyanine dyes, squarylium dyes, pyrylium salts, nickel thiolate complexes, and indolenine cyanine dyes. Furthermore cyanine dyes and indolenine cyanine dyes are more preferable.

In the present invention, specific examples of the cyanine dyes that can be suitably used include those described in paragraph 0017 to 0019 of JP-A-2001-133969, paragraph 0012 to 0038 of JP-A-2002-40638, and paragraph 0012 to 0023 of JP-A-2002-23360.

From the viewpoint of an efficiency of a photothermal conversion, dyes represented by Formulae (d) or (e) are preferable.

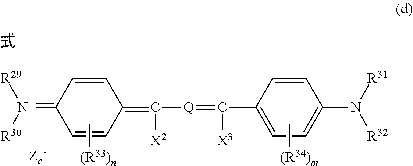

In Formula (d), R²⁹ to R³² each independently represent a hydrogen atom, an alkyl group, or an aryl group. R³³ and R³⁴ each independently represent an alkyl group, a substituted oxy group, or a halogen atom. n and m each independently represent an integer of 0 to 4. R²⁹ and R³⁰ or R³¹ and R³² may be bonded with each other to form a ring. Also, R²⁹ and/or R³⁰ and R³³ or R³¹ and/or R³² and R³⁴ may be bonded with each other to form a ring. Further, when plural R³³'s or R³⁴'s are present, the R³³'s or R³⁴'s may be bonded with each other to form a ring. X² and X³ each independently represent a hydrogen atom, an alkyl group, or an aryl group, provided that at least one of X² and X³ represents a hydrogen atom or an alkyl group. Q represents a trimethine group or a pentamethine group which may have a substituent, and may form a ring structure together with a divalent organic group. Z_{c}⁻ represents a counter anion. However, Z_{c}⁻ is not necessary when the dye represented by Formula (d) has an anionic substituent in the structure thereof and neutralization of charge is not needed. In view of the preservation stability of a coating liquid for the relief-forming layer, preferable examples of the counter ion for Z_{c}⁻ include a halogen ion, a perchlorate ion, a tetrafluoroborate ion, a hexafluorophosphate ion, and a sulfonate ion, and particularly preferable examples thereof include a perchlorate ion, a hexafluorophosphate ion, and an arylsulfonate ion.

In the present invention, specific examples of the dye represented by Formula (d) that can be suitably used include dyes shown below.

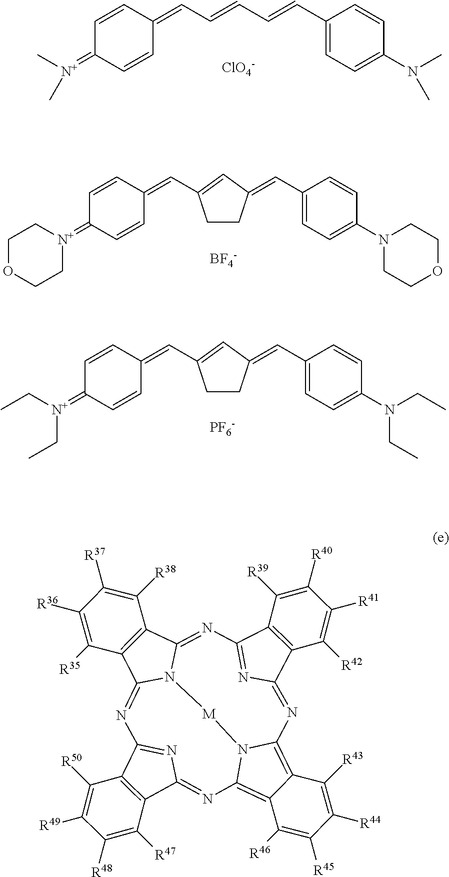

In Formula (e), R³⁵ to R⁵⁰ each independently represent a hydrogen atom, a halogen atom, a cyano group, an alkyl group, an aryl group, an alkenyl group, an alkynyl group, a hydroxy group, a carbonyl group, a thio group, a sulfonyl group, a sulfinyl group, an oxy group, an amino group, or an onium salt structure. When a substituent can be introduced into these groups, they may have the substituent. M represents two hydrogen atoms, a metal atom, a halometal group, or an oxymetal group, and examples of the metal atom included therein include atoms of Groups 1, 2, 13, and 14 of the Periodic Table, transition metals of the first, second and third periods, and lanthanoid elements. Among them, copper, magnesium, iron, zinc, cobalt, aluminum, titanium, and vanadium are preferred.

In the present invention, specific examples of the dye represented by Formula (e) that can be suitably used include dyes shown below.

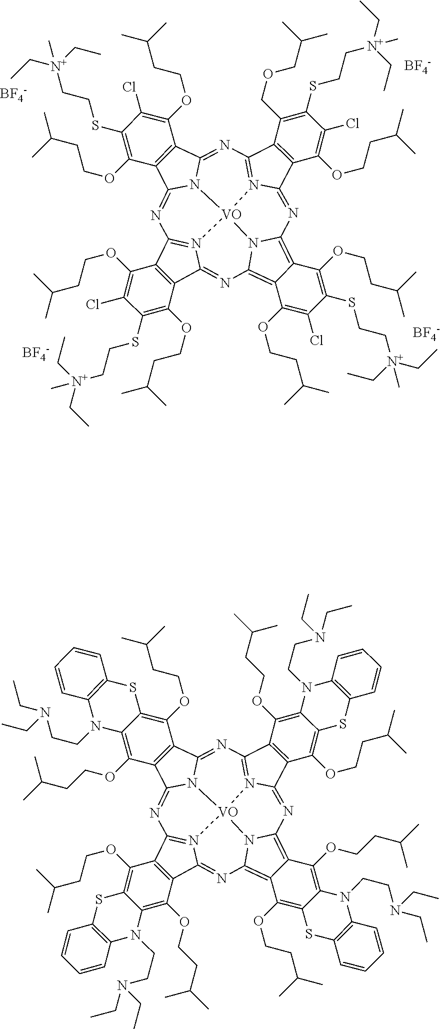

Examples of the pigment used in the present invention include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Current Pigment Application Technologies) (CMC Publishing Co., Ltd., 1986), and ‘Insatsu Inki Gijutsu’ (Printing Ink Technologies) (CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, inorganic pigments, and carbon black. Among these pigments, carbon black is particularly preferable.

These pigments may be used with or without a surface treatment.

The methods of the surface treatment include methods of coating a resin or wax onto the surface, applying a surfactant, binding a reactive substance (e.g., a silane coupling agent, an epoxy compound, a polyisocyanate, and the like) to the pigment surface, and the like. The above-mentioned surface treatment methods are described in Kinzoku Sekken No Seishitsu To Ohyo (Properties and Applications of Metallic Soaps), published by Saiwai Shobo; Insatsu Inki Gijutsu (Printing Ink Technologies), published by CMC Publishing Co., Ltd. (1984); and Saishin Ganryo Ohyo Gijutsu (Current Pigment Application Technologies), published by CMC Publishing Co., Ltd. (1986).

Furthermore, it is preferable to use a combination (conditions) of the photothermal conversion agent and the hydrophilic polymer in which a heat decomposition temperature of the photothermal conversion agent is the same as or higher than a heat decomposition temperature of the hydrophilic polymer, because the engraving sensitivity tends to further increase.

Specific examples of the photothermal conversion agent for use in the present invention include cyanine dyes such as a heptamethine cyanine dye, oxonol dyes such as a pentamethine oxonol dye, indolium dyes, benzindolium dyes, benzothiazolium dyes, quinolinium dyes, and phthalide compounds reacted with developers. It is not necessarily true that all cyanine dyes have the light absorbing properties described above. The light absorbing properties vary largely according to, for example, the kind and position of substituents in its molecule, number of conjugate bonds, kinds of counter ions or surrounding environment in which the dye molecules are present.

Moreover, ordinarily commercially available laser dyes, supersaturation absorption dyes, and near infrared absorption dyes may also be used. Examples of the laser dye include “ADS740PP”, “ADS745HT”, “ADS760MP”, “ADS740WS”, “ADS765WS”, “ADS745HO”, “ADS790NH”, and “ADS800NH”, all trade names of American Dye Source, Inc. (Canada), and “NK-3555”, “NK-3509”, and “NK-3519”, all trade names of Hayashibara Biochemical Labs., Inc. Examples of the near infrared absorption dye include “ADS775MI”, “ADS775MP”, “ADS775HI”, “ADS775PI”, “ADS775PP”, “ADS780MT”, “ADS780BP”, “ADS793EI”, “ADS798MI”, “ADS798MP”, “ADS800AT”, “ADS805PI”, “ADS805PP”, “ADS805PA”, “ADS805 PF”, “ADS812MI”, “ADS815EI”, “ADS818HT”, “ADS818HT”, “ADS822MT”, “ADS830AT”, “ADS838MT”, “ADS840MT”, “ADS845BI”, “ADS905AM”, “ADS956BI”, “ADS1040T”, “ADS1040P”, “ADS1045P”, “ADS1050P”, “ADS1060A”, “ADS1065A”, “ADS1065P”, “ADS1100T”, “ADS1120F”, “ADS1120P”, “ADS780WS”, “ADS785WS”, “ADS790WS”, “ADS805WS”, “ADS820WS”, “ADS830WS”, “ADS850WS”, “ADS780HO”, “ADS810CO”, “ADS820HO”, “ADS821 NH”, “ADS840NH”, “ADS880MC”, “ADS890MC”, and “ADS920MC”, all trade names of American Dye Source, Inc. (Canada), “YKR-2200”, “YKR-2081”, “YKR-2900”, “YKR-2100”, and “YKR-3071”, all trade names of Yamamoto Chemicals Inc., “SDO-1000B”, trade name of Arimoto Chemical Co., Ltd., “NK-3508” and “NKX-114”, both trade names of Hayashibara Biochemical Labs., Inc. However, the present invention should not be construed as being limited thereto.

As the phthalide compound reacted with developer, those described in Japanese Patent Application No. 3271226 may also be used. Further, a phosphoric ester metal compound, for example, complexes of phosphoric ester and cupper salt described in JP-A-6-345820 and the pamphlet of WO99/10354 may be used. Moreover, fine particles having a light absorption property in a near infrared region and a volume-average particle diameter of preferably 0.3 μm or less, more preferably 0.1 μm or less, and yet more preferably 0.08 μm or less may be used. For instance, fine particles of metal oxide, for example, yttrium oxide, tin oxide and/or indium oxide, copper oxide or iron oxide and of metals such as gold, silver, palladium, and platinum are illustrated. Moreover, fine particles, for example, of glass having a volume-average particle diameter of preferably 5 μm or less, more preferably 1 μm or less, to which metal ions such as ions of copper, tin, indium, yttrium, chromium, cobalt, titanium, nickel, vanadium, and rare earth elements are added may also be used. Furthermore, the particles may be incorporated into microcapsules. In such a case, a volume-average particle diameter of the microcapsule is preferably 10 μm or less, more preferably 5 μm or less, and yet more preferably 1 μm or less. Ion exchange particles to which metal ions such as ions of copper, tin, indium, yttrium, and rare earth elements are adsorbed may also be used. The ion exchange particles may be resin particles or inorganic particles. Examples of the inorganic particles include particles of amorphous zirconium phosphate, amorphous zirconium silicate phosphate, amorphous zirconium hexamethaphosphate, layered zirconium phosphate, reticular zirconium phosphate, zirconium tungstate, and zeolite. Examples of the resin particles include particles of ordinarily used ion exchange resins and ion exchange cellulose.

Particularly preferred examples of the photothermal conversion agent include carbon black from the viewpoint of a stability and efficiency of the photothermal conversion.

In addition to standardized products classified by ASTM, any carbon black which generally used for various purpose such as coloring, rubber, and dry cell, etc. may be preferably used as long as dispersibility, etc. of the composition forming the relief-forming layer is stable.

Carbon black mentioned here includes for example furnace black, thermal black, channel black, lamp black, and acetylene black, etc.

In order to make dispersion easy, a black colorant such as carbon black may be used for producing a composition for a relief-forming layer as color chips or a color paste by dispersing it in a nitrocellulose or a binder in advance using, as necessary, a dispersant. Such chips and paste are readily available as commercial products.

In the present invention, it is possible to use carbon black having a relatively low specific surface area and a relatively low dibutyl phthalate (DBP) absorption and also finely divided carbon black having a large specific surface area.

Preferred commercial examples of carbon black include Printex (registered trademark) U, Printex (registered trademark) A, and Spezialschwarz (registered trademark) 4, which are manufactured by Degussa Corporation, SEAST (registered trademark) 600 (ISAF-LS) manufactured by TOKAI CARBON Co., Ltd., and, ASAHI (registered trademark) #70 (N-330) and ASAHI #80 (N-220) manufactured by ASAHI CARBON Co., Ltd.

In the present invention, from the viewpoint of the dispersing properties of the resin composition for laser engraving, carbon black with an oil absorption amount of less than 150 ml/100 g is preferred.

For selection of such carbon black, reference may be made to, for example, “Carbon Black Handbook”, edited by the Carbon Black Association.

When carbon black with an oil absorption amount of less than 150 ml/100 g is used, good dispersing properties in the relief-forming layer can be obtained, which is thus preferable. On the other hand, when carbon black with an oil absorption amount of 150 ml/100 g or more is used, the dispersing properties in the coating liquid for a relief-forming layer tend to be poor, and thus, aggregation of carbon black easily occurs. This leads to irregularities in the sensitivity, which is thus not preferable. Further, in order to prevent the aggregation, it is necessary to enhance the dispersion of carbon black in the preparation of a coating liquid.

As a method of dispersing Component B, known dispersion techniques that are used in the ink production or toner production can be employed. Examples of dispersion machines include an ultrasonic dispersion machine, a paint shaker, a sand mill, an attritor, a pearl mill, a super mill, a ball mill, an impeller, a disperser, a KD mill, a colloid mill, a dynatron, a three-roll mill, and a pressure kneader. The details are described in Saishin Ganryo Ohyo Gijutsu (Current Pigment Application Technologies), published by CMC Publishing Co., Ltd. (1986).

The content of Component B depends on the size of the molecular extinction coefficient characteristic to the molecule, and is in a range of 1 to 15 wt % relative to the total weight of the solids content of the resin composition for laser engraving, preferably 1 to 10 wt %, particularly preferably 1.5 to 5 wt %.

The content ratio of Component B to Content A is preferably 5 to 500 wt % relative to 100 wt % of Content A, more preferably 20 to 400 wt %, and particularly preferably 100 to 400 wt %.

The volume-average particle size of Component B is preferably in the range of 0.001 to 10 μm, more preferably 0.05 to 10 μm, and yet more preferably 0.1 to 7 μm.

The volume-average particle size of Component B may be measured using a laser-scattering type particle size distribution analyzer.

### (Component C) Binder Polymer

Component C comprised in the resin composition for laser engraving of the present invention is explained below.

The binder polymer is a binding resin having a molecular weight of 500 to 1,000,000 and is not particularly limited. Common high molecular compounds can appropriately be selected, and one type thereof may be used on its own, or two or more types may be used in combination. In particular, it is preferable for the binder polymer to be selected in consideration of various performances such as laser engraving property, ink acceptance property, and engraving residue dispersibility.

The binder polymer may be selected and used from a polystyrene resin, a polyester resin, a polyamide resin, a polysulfone resin, a polyether sulfone resin, a polyimide resin, a hydroxyethylene unit-containing hydrophilic polymer, an acrylic resin, an acetal resin, an epoxy resin, a polycarbonate resin, a rubber, and a thermoplastic elastomer, or the like.

For example, from the viewpoint of the laser engraving sensitivity, polymers having a partial structure capable of being thermally decomposed by exposure or heating are preferable. Examples of such polymers preferably include those described in paragraph 0038 of JP-A-2008-163081. Moreover, for example, when the purpose is to form a film having softness and flexibility, a soft resin or a thermoplastic elastomer is selected. It is described in detail in paragraphs 0039 to 0040 of JP-A-2008-163081. Furthermore, from the viewpoint of easy preparation of the composition for the relief-forming layer, and the improvement of resistance properties for an oil-based ink in the obtained flexo printing plate, the use of a hydrophilic or alcoholphilic polymer is preferable. As the hydrophilic polymer, those described in detail in paragraph 0041 of JP-A-2008-163081 can be used.

In addition, when being used for the purpose of curing by heating or exposure and improving strength, a polymer having a hydroxy group, an alkoxy group, a hydrolyzable silyl group, a silanol group, and an ethylenically unsaturated bond, etc. in the molecule is preferably used.

The above reactive functional group may be present at any locations in polymer molecules, but is preferably present at the side chain of the branched polymer. Preferred examples of such a polymer include a vinyl copolymer (copolymer of a vinyl monomer such as polyvinyl alcohol and polyvinyl acetal, and a derivative thereof) and an acrylic resin (copolymer of an acryl-based monomer such as hydroxyethyl (meth)acrylate, and a derivative thereof).

A method of introducing the reactive functional group into the binder polymer is not particularly limited, and a method of addition-(co)polymerizing or addition-polycondensating a monomer having the reactive functional group and a method in which, after synthesizing a polymer having a group which can be introduced into the reactive functional group, the group of the polymer is introduced into the reactive functional group by polymer reaction are included thereto.

As the binder polymer, in particular, (Component C-1) a binder polymer having a hydroxy group is preferably used and will be described below.

### (Component C-1) Binder Polymer Having a Hydroxy Group

(Component C-1) a binder polymer having a hydroxy group (hereinafter, appropriately also referred to as a ‘specific polymer’) is preferable for the binder polymer in the resin composition for laser engraving of the present invention. This specific polymer is preferably insoluble in water and soluble in alcohol having 1 to 4 carbons.

For a flexo printing plate precursor satisfying both good durability properties for an aqueous ink and for a UV ink and having a high engraving sensitivity and good film performance, preferred examples of Component C-1 include polyvinyl acetals and derivatives thereof, acrylic resins having a hydroxy group on a side chain, and epoxy resins having a hydroxy group on a side chain, etc.

A glass transition temperature (Tg) of Component C-1 is preferably at least 20° C. When Component C-1 is combined with Component B, that is, a photothermal conversion agent which can absorb light having a wavelength of 700 to 1,300 nm, and the glass transition temperature (Tg) of Component C-1 is at least 20° C., improvement of engraving sensitivity can be obtained. A binder polymer having such a glass transition temperature is also called a non-elastomer below. The upper limit for the glass transition temperature of the polymer is not limited, but is preferably no greater than 200° C. from the viewpoint of ease of handling, and is more preferably 25 to 120° C.

When a polymer having a glass transition temperature of room temperature (20° C.) or greater is used, a specific polymer is in a glass state at normal temperature. Because of this, compared with a case of a rubber state, thermal molecular motion is suppressed. In laser engraving, it is surmised that in addition to the heat given by an infrared laser during laser irradiation, the heat generated by the function of (Component B) a photothermal conversion agent which can absorb light having a wavelength of 700 to 1,300 nm is transmitted to the surrounding specific polymer, and this polymer is thermally decomposed and disappears, thereby forming an engraved recess.

In case of using the specific polymer, it is surmised that when a photothermal conversion agent is present in a state in which thermal molecular motion of the specific polymer is suppressed, heat transfer to and thermal decomposition of the specific polymer occur effectively. It is anticipated that such an effect further increases the engraving sensitivity.

Specific examples of the polymer that is the non-elastomer preferably used in the present invention are cited below.

### (1) Polyvinyl Acetal and its Derivative

Polyvinyl acetal is a compound obtained by converting polyvinyl alcohol (obtained by saponifying polyvinyl acetate) into a cyclic acetal. The polyvinyl acetal derivative is a derivative obtained by modifying the polyvinyl acetal or adding another copolymer constituent.

The acetal content in the polyvinyl acetal derivative (mole % of vinyl alcohol units converted into acetal relative to the total number of moles of vinyl acetate monomer starting material as 100 mole %) is preferably 30 to 90 mole %, more preferably 50 to 85 mole %, and particularly preferably 55 to 78 mole %.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerized constitutional unit.

Examples of the polyvinyl acetal include polyvinyl butyral, polyvinyl propylal, polyvinyl ethylal, and polyvinyl methylal. Among them, polyvinyl butyral derivative (PVB) is preferably used.

Polyvinyl butyral is a polymer conventionally obtained by converting polyvinyl alcohol into polyvinylbutyral. Polyvinyl butyral derivatives may be also used.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified with a (meth)acryloyl group, a modified PVB in which at least some of the hydroxy groups are modified with an amino group, a modified PVB in which at least some of the hydroxy groups have introduced thereinto ethylene glycol, propylene glycol, or a multimer thereof.

From the viewpoint of a balance being achieved between engraving sensitivity and film formation properties, the weight-average molecular weight of the polyvinyl acetal is preferably 5,000 to 800,000, more preferably 8,000 to 500,000 and, from the viewpoint of improvement of rinsing properties for engraving residue, particularly preferably 50,000 to 300,000.

Hereinafter, polyvinyl butyral (PVB) and derivatives thereof are cited for explanation as particularly preferable examples of polyvinyl acetal, but are not limited to these.

Polyvinyl butyral has a structure as shown below, and is constituted while including these structural units.

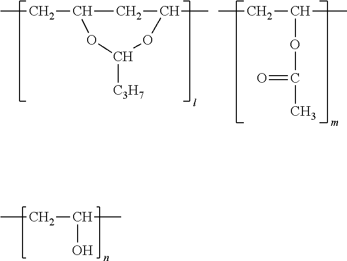

In the above formula, l, m, and n denote the content (mol %) of the respective repeating units in polyvinyl butyral, and the relationship I+m+n=100 is satisfied. The butyral content in the polyvinyl butyral and the derivative thereof (value of l in the formula above) is preferably 30 to 90 mole %, more preferably 40 to 85 mole %, and particularly preferably 45 to 78 mole %.

From the viewpoint of a balance being achieved between engraving sensitivity and film formation properties, the weight-average molecular weight of the polyvinyl butyral and the derivative thereof is preferably 5,000 to 800,000, more preferably 8,000 to 500,000 and, from the viewpoint of improvement of rinsing properties for engraving residue, particularly preferably 50,000 to 300,000.

The PVB derivative is also available as a commercial product, and preferred examples thereof include, from the viewpoint of alcohol dissolving capability (particularly, ethanol), “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol dissolving capability (particularly, ethanol), “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values l, m, and n in the above formulae and the molecular weight. Examples of “S-REC B” series manufactured by SEKISUI CHEMICAL CO., LTD. include “BL-1” (l=61, m=3, n=36, weight-average molecular weight: 19,000), “BL-1H” (l=67, m=3, n=30, weight-average molecular weight: 20,000), “BL-2” (l=61, m=3, n=36, weight-average molecular weight: about 27,000), “BL-5” (l=75, m=4, n=21, weight-average molecular weight: 32,000), “BL-S” (l=74, m=4, n=22, weight-average molecular weight: 23,000), “BM-S” (l=73, m=5, n=22, weight-average molecular weight: 53,000), and “BH-S” (l=73, m=5, n=22, weight-average molecular weight: 66,000), and examples of “DENKA BUTYRAL” manufactured by DENKI KAGAKU KOGYO include “#3000-1” (l=71, m=1, n=28, weight-average molecular weight: 74,000), “#3000-2” (l=71, m=1, n=28, weight-average molecular weight: 90,000), “#3000-4” (l=71, m=1, n=28, weight-average molecular weight: 117,000), “#4000-2” (l=71, m=1, n=28, weight-average molecular weight: 152,000), “#6000-C” (l=64, m=1, n=35, weight-average molecular weight: 308,000), “#6000-EP” (l=56, m=15, n=29, weight-average molecular weight: 381,000), “#6000-CS” (l=74, m=1, n=25, weight-average molecular weight: 322,000), and “#6000-AS” (l=73, m=1, n=26, weight-average molecular weight: 242,000).

When the relief-forming layer is formed using the PVB derivative as a specific polymer, a method of casting and drying a solution in which the polymer is dissolved in a solvent is preferable from the viewpoint of smoothness of the film surface.

### (2) An Acrylic Resin

As an acrylic resin usable as a specific polymer, an acrylic resin may be used which can be synthesized from an acrylic monomer having a hydroxy group in the monomer.

Preferable examples of the acrylic monomer used for producing an acrylic resin having a hydroxy group include a (meth)acrylic acid ester, a crotonic acid ester, or a (meth)acrylamide that has a hydroxy group in the molecule. Specific examples of such a monomer include 2-hydroxyethyl (meth)acrylate, 2-hydroxypropyl (meth)acrylate, and 4-hydroxybutyl (meth)acrylate.

In the present invention ‘(meth)acryl’ means ‘acryl’ and/or ‘methacryl’ and ‘(meth)acrylate’ means ‘acrylate’ and/or ‘methacrylate.’

The acrylic resin may be constituted from a known acrylic comonomer other than the acrylic monomer having a hydroxy group explained above. As the known (meth)acrylic comonomer, the (meth)acrylic monomer can be cited, and specific examples thereof include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, lauryl (meth)acrylate, 2-ethylhexyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, t-butylcyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, the monomethyl ether (meth)acrylate of a copolymer of ethylene glycol and propylene glycol, N,N-dimethylaminoethyl (meth)acrylate, N,N-diethylaminoethyl (meth)acrylate, and N,N-dimethylaminopropyl (meth)acrylate.

Furthermore, a modified acrylic resin formed with a urethane group- or urea group-containing acrylic monomer may preferably be used.

Among these, from the viewpoint of aqueous ink resistance, an alkyl (meth)acrylate such as lauryl (meth)acrylate and an aliphatic cyclic structure-containing (meth)acrylate such as t-butylcyclohexyl (meth)acrylate are particularly preferable.

### (3) A Novolac Resin

Furthermore, as the specific polymer, a novolac resin may be used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin between a mixture of phenol/cresol (any of m-, p-, o- or m-/p-, m-/o-, o-/p- mixtures) and formaldehyde.

With regard to these novolac resins, those having a weight-average molecular weight of 800 to 200,000 and a number-average molecular weight of 400 to 60,000 are preferable.

An epoxy resin having a hydroxy group in a side chain may be used as a specific polymer. A preferred specific example of the epoxy resin is an epoxy resin formed by polymerization, as a starting material monomer, of an adduct of a bisphenol A and an epichlorohydrin. The epoxy resin preferably has a weight-average molecular weight of 800 to 200,000, and a number-average molecular weight of 400 to 60,000.

Among specific polymers, polyvinyl butyral derivatives are particularly preferable from the viewpoint of rinsing properties and printing durability when the polymer is applied into the relief-forming layer.

In polymers of any embodiment described above, the content of the hydroxy group contained in the specific polymer in the present invention is preferably 0.1 to 15 mmol/g, and more preferably 0.5 to 7 mmol/g.

In the flexo printing plate precursor for laser engraving, in addition to the above specific polymer, a known polymer not included in the specific polymer, such as a polymer containing no hydroxyl group, may be used alone or in combination with the specific polymer. This polymer may also be hereinafter referred to as an ordinary polymer.

The ordinary polymer constitutes the main component included in the flexo printing plate precursor for laser engraving, together with the specific polymer, and an ordinary polymer compound not included in the specific polymer may be arbitrarily selected and used singly or in combination of two or more kinds thereof. Particularly, when the relief-forming plate precursor is used in the printing plate precursor, it is necessary to select the binder polymer, taking into consideration various types of performance such as laser engraving properties, ink wetting properties, and engraving residue-dispersing properties.

The common polymer may be selected and used from a polystyrene resin, a polyester resin, a polyamide resin, a polyureapolyamideimide resin, a polyurethane resin, a polysulfone resin, a polyether sulfone resin, a polyimide resin, a polycarbonate resin, a rubber, and a thermoplastic elastomer, etc.

For example, from the viewpoint of laser engraving sensitivity, a polymer comprising a partial structure that is thermally decomposed by exposure or heating is preferable. As such polymer, those described in paragraph 0038 of JP-A-2008-163081 are preferably cited. Moreover, when a purpose is to form a film that has softness and flexibility, a soft resin or a thermoplastic elastomer is selected. There is detailed description in paragraphs 0039 to 0040 of JP-A-2008-163081. From the viewpoint of easiness of preparing a composition for the relief-forming layer and improvement of resistance properties for an oil-based ink in the flexo printing plate to be obtained, the use of a hydrophilic or alcoholphilic polymer is preferable. As the hydrophilic polymer, those described in detail in paragraph 0041 of JP-A-2008-163081 can be used.

Component C may be used singly or in a combination of two or more kinds thereof in the resin composition for laser engraving of the present invention.

From the viewpoint of satisfying a shape-maintaining property, water resistance, and engraving sensitivity of a coated film with excellent balance, the content of Component C in the resin composition for laser engraving of the present invention is preferably from 2 to 95 wt %, more preferably from 5 to 80 wt %, and particularly preferably from 10 to 60 wt %, relative to a total solid content of the resin composition for laser engraving of the present invention.

The flexo printing plate precursor for laser engraving of the present invention may comprise other various type of components as necessary such as (Component D) a polymerizable compound (a monomer), (Component E) a compound having at least one type of a hydrolyzable silyl group and/or silanol groups, (Compound F) an alcohol exchange catalyst, and an initiator, etc. in addition to Component A, Component B, or Component C.

Other components such as Component D, Component E, and Component F are explained below.

### (Component D) Polymerizable Compound

The resin composition for laser engraving of the present invention preferably comprises a polymerizable compound (a monomer). Embodiment in which an ethylenically unsaturated compound is used as the polymerizable compound is explained in detail below.

A compound having at least one ethylenically unsaturated bond which is a polymerizable compound preferably used in the present invention is selected from the compound having at least one, and preferably two or more, ethylenically unsaturated bonds at the teminal. A group of such compounds is widely known in the present industrial field, and they may be used in the present invention without particular limitations. They have a chemical form such as, for example, a monomer, a prepolymer such as a dimer or a trimer, an oligomer, a mixture thereof, or a copolymer thereof.

Examples of the monomer and a copolymer thereof include unsaturated carboxylic acids (e.g. acrylic acid, methacrylic acid, itaconic acid, crotonic acid, isocrotonic acid, maleic acid, etc.), esters thereof, and amides thereof, and an ester of an unsaturated carboxylic acid and an aliphatic polyhydric alcohol compound or an amide of an unsaturated carboxylic acid and an aliphatic polyamine compound is preferably used. Furthermore, an addition reaction product of an unsaturated carboxylic acid ester or amide having a nucleophilic substituent such as a hydroxy group, an amino group, or a mercapto group with a monofunctional or polyfunctional isocyanate or epoxide, a dehydration-condensation reaction product between the ester or the amide and a monofunctional or polyfunctional carboxylic acid, etc. may also be used suitably. Furthermore, an addition reaction product of an unsaturated carboxylic acid ester or amide having an electrophilic substituent such as an isocyanato group or an epoxy group with a monofunctional or polyfunctional alcohol, amine, or thiol, and a substitution reaction product of an unsaturated carboxylic acid ester or amide having a leaving substituent such as a halogen group or a tosyloxy group with a monofunctional or polyfunctional alcohol, amine, or thiol are also suitable. Furthermore, as other examples, a group of compounds in which the above-mentioned unsaturated carboxylic acid is replaced by an unsaturated phosphonic acid, styrene, vinyl ether, etc. may also be used.

Specific examples of the monomer that is an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include diethylene glycol dimethacrylate, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, bis[p-(methacryloxyethoxy)phenyl]dimethylmethane, and toricyclodecanedimethanol dimethacrylate.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

As isocrotonic acid esters there can be cited ethylene glycol diisocrotonate, pentaerythritol diisocrotonate, and sorbitol tetraisocrotonate.

As maleic acid esters there can be cited ethylene glycol dimaleate, triethylene glycol dimaleate, pentaerythritol dimaleate, and sorbitol tetramaleate.

As examples of other esters, aliphatic alcohol-based esters described in JP-B-46-27926, JP-B-51-47334, and JP-A-57-196231, those having an aromatic skeleton described in JP-A-59-5240, JP-A-59-5241, and JP-A-2-226149, and those having an amino group described in JP-A-1-165613, etc. may also be used suitably. Moreover, the above-mentioned ester monomers may be also used as a mixture.

Furthermore, specific examples of monomers that are amides of an aliphatic polyvalent amine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include cyclohexylene structure-containing ones described in JP-B-54-21726.

Furthermore, an urethane-based polymerizable compound which is prepared by an addition reaction of an isocyanate and a hydroxy group may be also suitable. Specific examples thereof include a vinylurethane compound described in JP-B-48-41708 containing two or more polymerizable vinyl groups per molecule in which a hydroxy group-containing vinyl monomer represented by Formula (I) below is added to a polyisocyanate compound having two or more isocyanate groups per molecule.

CH₂═C(R)COOCH₂CH(R′)OH (I)

(Here, R and R′ denote H or CH₃.)

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, and JP-B-62-39418 are also suitable.

Furthermore, a photopolymerizable composition having extremely good photosensitive speed can be obtained by the use of polymerizable compounds having an amino structure or a sulfide structure in the molecule described in JP-A-63-277653, JP-A-63-260909, and JP-A-1-105238.

Other examples include polyfunctional acrylates and methacrylates, for example, polyester acrylates and epoxy acrylates obtained by reacting an epoxy resin with (meth)acrylic acid that are described in JP-A-48-64183, JP-B-49-43191, and JP-B-52-30490. Further examples include specific unsaturated compounds described in JP-B-46-43946, JP-B-1-40337, and JP-B-1-40336 and vinylphosphonic acid-based compounds described in JP-A-2-25493. In some cases, a perfluoroalkyl group-containing structure described in JP-A-61-22048 is suitably used. Moreover, photocurable monomers or oligomers described in Nippon Secchaku Kyokaishi (Journal of Japan Adhesion Society), Vol. 20, No. 7, pp. 300-308 (1984) can also be used.

In view of the photosensitivity speed, a structure having a large content of unsaturated groups per molecule is preferred and in many cases, a difunctional or higher functional compound is preferred. In order to increase the strength of the image area, that is, the cured film, a trifunctional or higher functional compound is preferred. Further, a combined use of compounds of different functional degree or different kind of polymerizable group (for example, an acrylic acid ester, a methacrylic acid ester, a styrene compound, and a vinyl ether compound) is an effective method for controlling both the sensitivity and the strength.

The polymerizable compound is used preferably in the range of 2 to 90 wt %, and more preferably in the range of 5 to 85 wt %, relative to the total solid content weight of the resin composition for laser engraving. Further, the polymerizable compounds may be used singly or in combination of two or more kinds thereof.

(Component E) Compound Having at Least One Type of Hydrolyzable Silyl Group and/or Silanol Groups

The ‘hydrolyzable silyl group’ of (Component E) a compound having at least one type of hydrolyzable silyl group and/or a silanol group (hereinafter, called ‘Component E’ as appropriate) used in the resin composition for laser engraving of the present invention is a silyl group that is hydrolyzable; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (1) below.

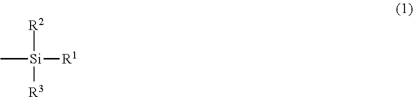

In Formula (1) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group. The remainder of R¹ to R³ independently denote a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component E in the present invention is preferably a compound having one or more groups represented by Formula (1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component E is preferably at least 2 but no greater than 6, and most preferably 2 or 3.

A range of 1 to 4 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

Component E preferably has at least a sulfur atom, an ester bond, a urethane bond, an ether bond, a urea bond, or an imino group.

Among them, from the viewpoint of crosslinkability, Component E preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which is easily decomposed by aqueous alkali. A Component E containing a sulfur atom functions as a vulcanizing agent or a vulcanization accelerator when carrying out a vulcanization treatment, thus promoting a reaction (crosslinking) of a conjugated diene monomer unit-containing polymer. As a result, the rubber elasticity necessary as a printing plate is exhibited. Furthermore, the strength of a crosslinked relief-forming layer and a relief layer is improved.

Furthermore, Component E in the present invention is preferably a compound that does not have an ethylenically unsaturated bond.

As Component E in the present invention, there can be cited a compound in which a plurality of groups represented by Formula (1) above are bonded via a divalent linking group, and from the viewpoint of the effect, such a divalent linking group is preferably a linking group having a sulfide group (—S—), an imino group (—N(R)—) a urea group or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing Component E is not particularly limited, and synthesis can be carried out by a known method. As one example, a representative synthetic method for a Component E containing a linking group having the above-mentioned specific structure is shown below.

Synthetic Method for Compound Having Sulfide Group as Linking Group and Having Hydrolyzable Silyl Group and/or Silanol Groups

A synthetic method for a Component E having a sulfide group as a linking group (hereinafter, called as appropriate a ‘sulfide linking group-containing Component E’) is not particularly limited, but specific examples thereof include reaction of a Component E having a halogenated hydrocarbon group with an alkali metal sulfide, reaction of a Component E having a mercapto group with a halogenated hydrocarbon, reaction of a Component E having a mercapto group with a Component E having a halogenated hydrocarbon group, reaction of a Component E having a halogenated hydrocarbon group with a mercaptan, reaction of a Component E having an ethylenically unsaturated double bond with a mercaptan, reaction of a Component E having an ethylenically unsaturated double bond with a Component E having a mercapto group, reaction of a compound having an ethylenically unsaturated double bond with a Component E having a mercapto group, reaction of a ketone with a Component E having a mercapto group, reaction of a diazonium salt with a Component E having a mercapto group, reaction of a Component E having a mercapto group with an oxirane, reaction of a Component E having a mercapto group with a Component E having an oxirane group, reaction of a mercaptan with a Component E having an oxirane group, and reaction of a Component E having a mercapto group with an aziridine.

Synthetic Method for Compound Having Imino Group as Linking Group and Having Hydrolyzable Silyl Group and/or Silanol Groups

A synthetic method for a Component E having an imino group as a linking group (hereinafter, called as appropriate an ‘imino linking group-containing Component E’) is not particularly limited, but specific examples include reaction of a Component E having an amino group with a halogenated hydrocarbon, reaction of a Component E having an amino group with a Component E having a halogenated hydrocarbon group, reaction of a Component E having a halogenated hydrocarbon group with an amine, reaction of a Component E having an amino group with an oxirane, reaction of a Component E having an amino group with a Component E having an oxirane group, reaction of an amine with a Component E having an oxirane group, reaction of a Component E having an amino group with an aziridine, reaction of a Component E having an ethylenically unsaturated double bond with an amine, reaction of a Component E having an ethylenically unsaturated double bond with a Component E having an amino group, reaction of a compound having an ethylenically unsaturated double bond with a Component E having an amino group, reaction of a compound having an acetylenically unsaturated triple bond with a Component E having an amino group, reaction of a Component E having an imine-based unsaturated double bond with an organic alkali metal compound, reaction of a Component E having an imine-based unsaturated double bond with an organic alkaline earth metal compound, and reaction of a carbonyl compound with a Component E having an amino group.

Synthetic Method for Compound Having Urea Bond as Linking Group and Having Hydrolyzable Silyl Group and/or Silanol Groups

A synthetic method for Component E having an urea group (hereinafter, called as appropriate a ‘urea linking group-containing Component E’) as a linking group is not particularly limited, but specific examples include synthetic methods such as reaction of a Component E having an amino group with an isocyanate ester, reaction of a Component E having an amino group with a Component E having an isocyanate ester, and reaction of an amine with a Component E having an isocyanate ester.

Component E is preferably a compound represented by Formula (A-1) or Formula (A-2) below.

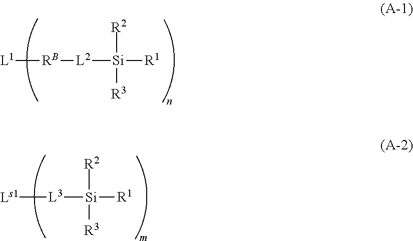

(In Formula (A-1) and Formula (A-2), R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent. In addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.)

R¹ to R³ in Formula (A-1) and Formula (A-2) above have the same meanings as those of R¹ to R³ in Formula (1) above, and preferred ranges are also the same.

From the viewpoint of rinsing properties and film strength, R^{B} above is preferably an ester bond or a urethane bond, and is more preferably an ester bond.

The divalent or n-valent linking group denoted by L¹ to L³ above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L¹ to L³ above is preferably 2 to 60, and more preferably 2 to 30.

The m-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

n and m above are preferably and independently integers of 1 to 10, more preferably integers of 2 to 10, yet more preferably integers of 2 to 6, and particularly preferably 2.

From the viewpoint of removability (rinsing properties) of engraving residue, the n-valent linking group denoted by L¹ and/or the divalent linking group denoted by L², or the divalent linking group denoted by L³ preferably has an ether bond, and more preferably has an ether bond contained in an oxyalkylene group.

Among compounds represented by Formula (A-1) or Formula (A-2), from the viewpoint of crosslinkability, etc., the n-valent linking group denoted by L¹ and/or the divalent linking group denoted by L² in Formula (A-1) are preferably groups having a sulfur atom.

Specific examples of Component E that can be applied to the present invention are shown below. Examples thereof include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, γ-mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl) disulfide, bis(triethoxysilylpropyl) tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane, trimethylsilanol, diphenylsilanediol, and triphenylsilanol. Other than the above, the compounds shown below can be cited as preferred examples, but the present invention should not be construed as being limited thereto.

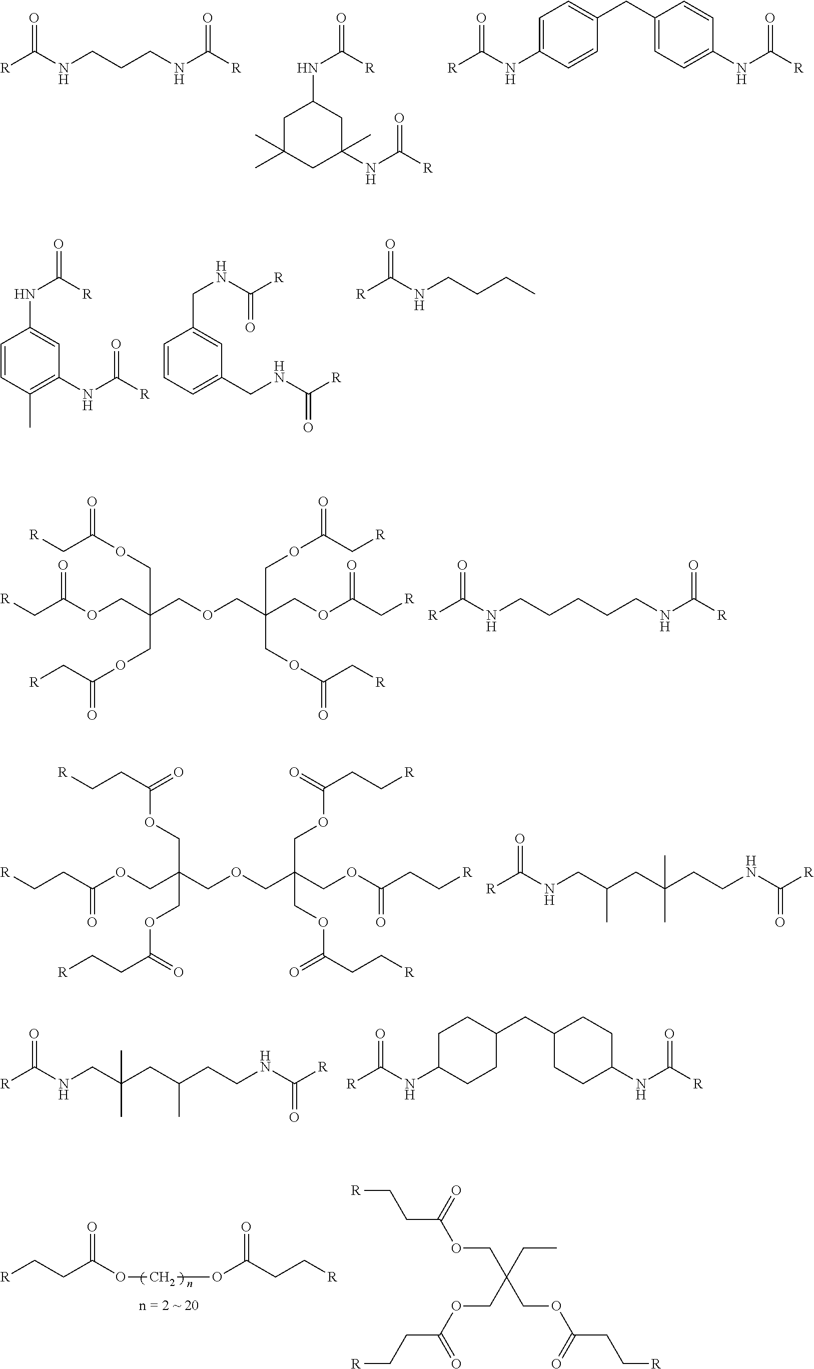

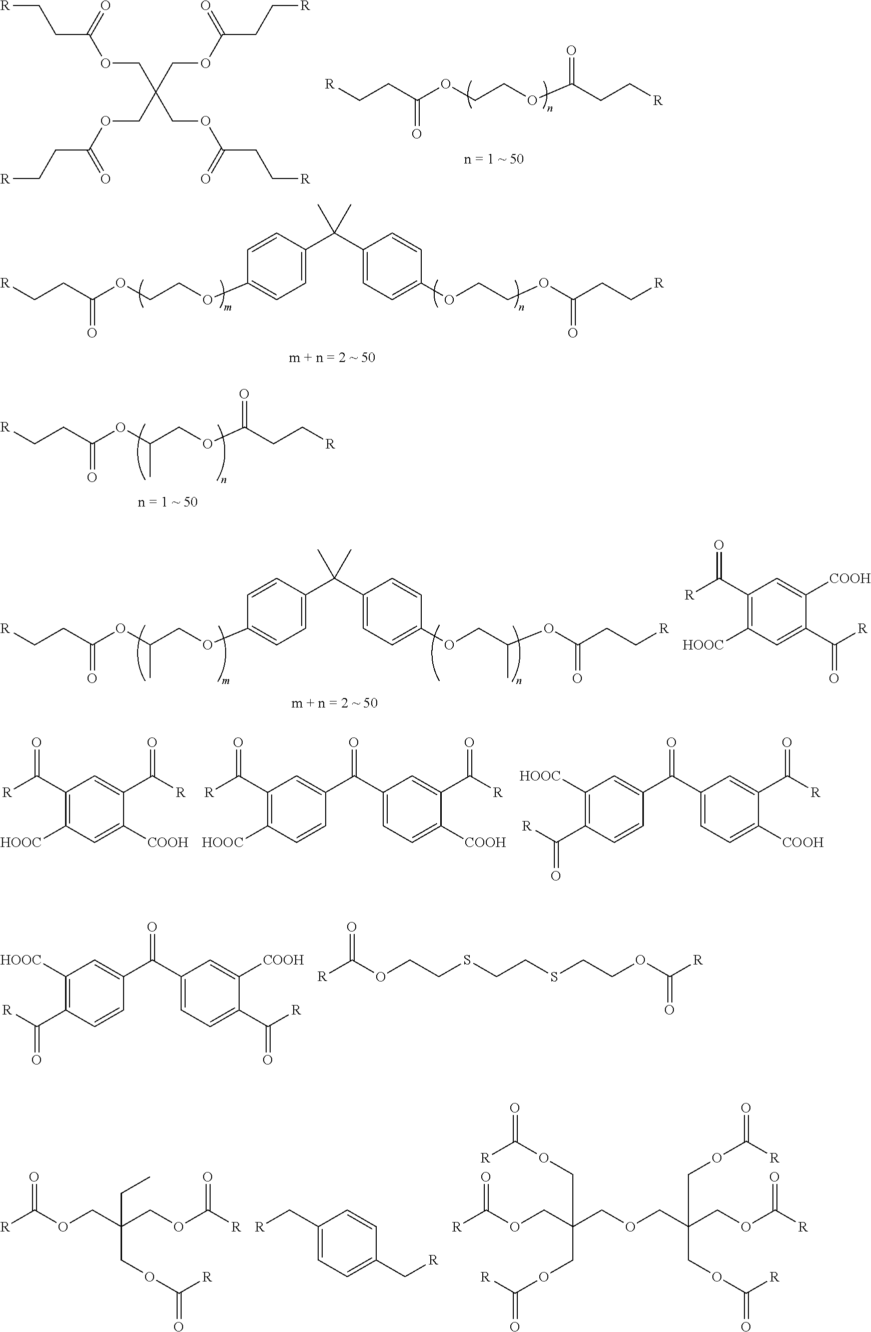

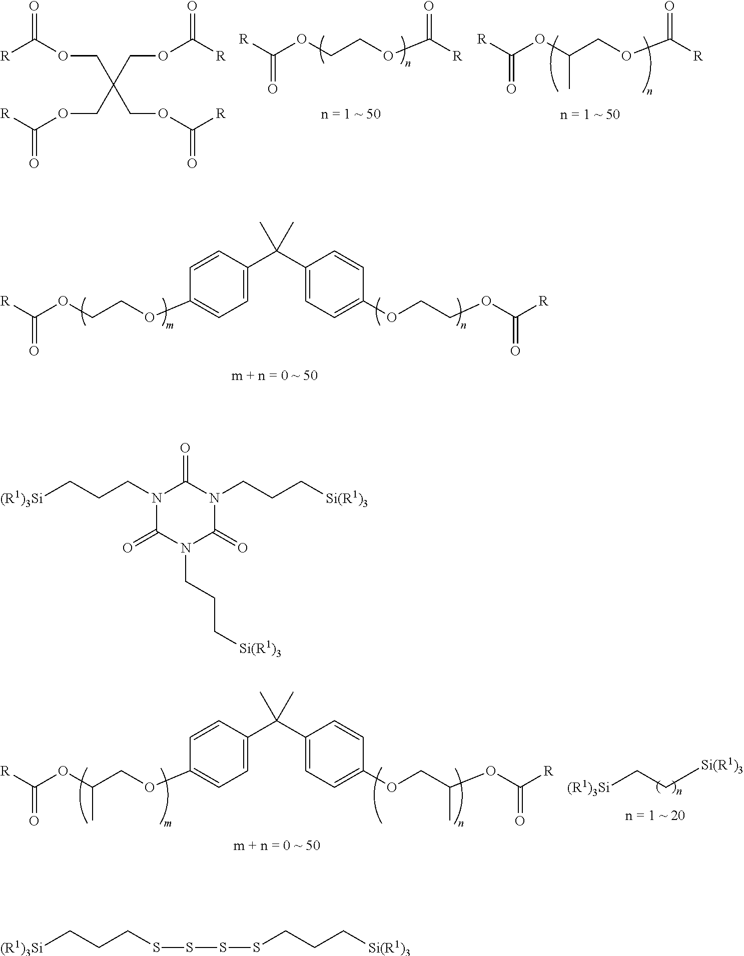

In each of the formulae above, R denotes a partial structure selected from the structures below. When a plurality of Rs and R¹s are present in the molecule, they may be identical to or different from each other, and are preferably identical to each other in terms of synthetic suitability.

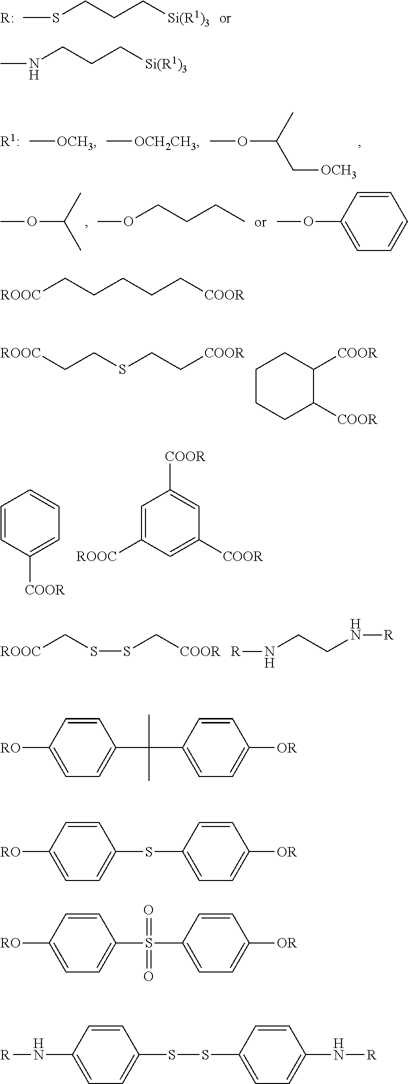

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

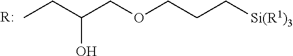

Component E may be obtained by synthesis as appropriate, but use of a commercially available product is preferable in terms of cost. Since Component E corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As Component E in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is desirable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial (co)hydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

With regard to Component E in the resin composition of the present invention, only one type may be used or two or more types may be used in combination.

The content of Component E contained in the resin composition of the present invention is preferably in the range of 0.1 to 80 wt % on a solids content basis, more preferably in the range of 1 to 40 wt %, and most preferably in the range of 5 to 30 wt %.

### (Component F) Alcohol Exchange Reaction Catalyst

When Component E is used for the resin composition of the present invention, (Component F) an alcohol exchange reaction catalyst is preferably comprised in order to promote a reaction of Component E with a specific binder polymer. The alcohol exchange reaction catalyst may be used without any restrictions as long as it is a reaction catalyst generally used in a silane coupling reaction. Hereinafter, an acidic or basic catalyst and a metal complex catalyst, which are representative alcohol exchange reaction catalysts, are explained in sequence.

### An Acidic or a Basic Catalyst

As the catalyst, an acidic or basic compound is used as it is or in the form of a solution in which it is dissolved in a solvent such as water or an organic solvent (hereinafter, also called an acidic catalyst or basic catalyst respectively). The concentration when dissolved in a solvent is not particularly limited, and it may be selected appropriately according to the properties of the acidic or basic compound used, desired catalyst content, etc.

An acidic or a basic catalyst is not particularly limited. Examples of the acidic catalyst include a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a carboxylic acid in which R of the structural formula RCOOH is substituted with another element or substituent, a sulfonic acid such benzenesulfonic acid, a phosphoric acid.

Examples of the basic catalyst include an ammoniacal base such as aqueous ammonia, and an amine such as ethylamine or aniline.

From the viewpoint of an alcohol exchange reaction in the layer progressing promptly, methanesulfonic acid, p-toluenesulfonic acid, pyridinium p-toluenesulfonate, phosphoric acid, phosphonic acid, acetic acid, 1,8-diazabicyclo[5.4.0]undec-7-ene, and hexamethylenetetramine are preferable, and methanesulfonic acid, p-toluenesulfonic acid, phosphoric acid, 1,8-diazabicyclo[5.4.0]undec-7-ene, and hexamethylenetetramine are particularly preferable.

### Metal Complex Catalyst

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from -diketones (acetylacetones are preferable), ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, ethyl orthotitanate, etc. is more preferable.

They are excellent in terms of stability in an aqueous coating solution and an effect in promoting gelling in a sol-gel reaction when thermally drying, and among them ethyl acetoacetate aluminum diisopropylate, aluminum tris(ethyl acetoacetate), a di(acetylacetonato)titanium complex salt, and zirconium tris(ethyl acetoacetate) are particularly preferable.

The resin composition of the present invention may employ only one type of alcohol exchange reaction catalyst or two or more types thereof in combination. The content of the alcohol exchange reaction catalyst in the resin composition is preferably 0.01 to 20 wt % relative to the specific polymer having a hydroxy group, and more preferably 0.1 to 10 wt %.

### Polymerization Initiator

In the resin composition for laser engraving of the present invention, a polymerization initiator may be preferably further comprised.

With regard to the polymerization initiator, one known to a person skilled in the art may be used without any limitations. Radical polymerization initiators, which are preferred polymerization initiators, are explained in detail below, but the present invention should not be construed as being limited to these descriptions.

In the present invention, preferred examples of the radical polymerization initiator include (a) an aromatic ketone, (b) an onium salt compound, (c) an organic peroxide, (d) a thio compound, (e) a hexaarylbiimidazole compound, (f) a ketoxime ester compound, (g) a borate compound, (h) an azinium compound, (i) a metallocene compound, (j) an active ester compound, (k) a compound having a carbon halogen bond, and (l) an azo-based compound. Specific examples of (a) to (l) above are listed below, but the present invention should not be construed as being limited thereto.

In the present invention, from the viewpoint of engraving sensitivity and good relief edge shape being obtained when applied to a relief-forming layer of a flexo printing plate precursor, an organic peroxide (c) and an azo-based compound (l) are preferable, and an organic peroxide (c) is particularly preferable.

As the aromatic ketone (a), onium salt compound (b), thio compound (d), hexaarylbiimidazole compound (e), ketoxime ester compound (f), borate compound (g), azinium compound (h), metallocene compound (i), active ester compound (j), and compound (k) having a carbon halogen bond, compounds described in paragraphs 0074 to 0118 of JP-A-2008-63554 may preferably be used.

As the organic peroxide (c) and the azo-based compound (l), the compounds shown below are particularly preferable.

### (c) Organic Peroxide

As the radical polymerization initiator that can be used in the present invention, preferable examples of the organic peroxide (c) include peroxyester-based compounds such as 3,3′4,4′-tetra(tert-butylperoxycarbonyl)benzophenone, 3,3′4,4′-tetra(tert-amylperoxycarbonyl)benzophenone, 3,3′4,4′-tetra(tert-hexylperoxycarbonyl)benzophenone, 3,3′4,4′-tetra(tert-octylperoxycarbonyl)benzophenone, 3,3′4,4′-tetra(cumylperoxycarbonyl)benzophenone, 3,3′4,4′-tetra(p-isopropylcumylperoxycarbonyl)benzophenone, di-tert-butyl diperoxyisophthalate, and tert-butyl peroxybenzoate.

### (l) Azo-Based Compound

As the radical polymerization initiator that can be used in the present invention, preferable examples of the azo-based compound (l) include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobisisobutyrate, 2,2′-azobis(2-methylpropionamidoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane).

With regard to the polymerization initiator in the present invention, one type may be used on its own or two or more types may be used in combination.

The content of the polymerization initiator is preferably 0.001 to 15 wt % relative to the total solids content by weight of the resin composition for laser engraving, and more preferably 0.002 to 10 wt %. When the content of the polymerization initiator is at least 0.001 wt %, an effect from the addition thereof is obtained, and crosslinking of a crosslinkable relief-forming layer proceeds promptly. Furthermore, when the content is no greater than 15 wt %, other components do not become insufficient, and printing durability that is satisfactory as a flexo printing plate is obtained.

### Other Components

The resin composition for laser engraving in the present invention may further comprise other components suitable for a purpose or a producing method. Preferred additives are shown below.

### Polymerization Inhibitor

In the present invention, in addition to the above-mentioned basic components, a small amount of a thermal polymerization inhibitor may be contained in order to inhibit undesired thermal polymerization of the compound having a polymerizable ethylenically unsaturated bond during the production process or the storage of the composition.

Examples of the suitable thermal polymerization inhibitors include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and a cerium (I) salt of N-nitrosophenylhydroxyamine.

The addition amount of the thermal polymerization inhibitor is preferably in the range of 0.01 to 10 wt % relative to the total solids content by weight of the resin composition for laser engraving.

Furthermore in order to avoid polymerization inhibition due to oxygen, a higher fatty acid derivative, for example, behenic acid or behenic amide may be added and allowed to localize on the photosensitive layer surface during the drying step after the coating onto a support, etc., as necessary.

The addition amount of the higher fatty acid derivative is preferably in the range of 0.5 to 15 wt % relative to the total solids content by weight of the resin composition for laser engraving.

### Filler

The filler may be any of an organic compound, an inorganic compound, or a mixture thereof. Examples of the organic compound include carbon black, carbon nanotubes, fullerene, and graphite. Examples of the inorganic compound include silica, alumina, aluminum, and calcium carbonate.

### Plasticizer

The plasticizer is a material having the function of softening the resin composition for laser engraving, and has necessarily a good compatibility relative to the binder polymer.

Examples of the plasticizer include diethylene glycol, dioctyl phthalate, didodecyl phthalate, triethylene glycol dicaprylate, dimethyl glycol phthalate, tricresyl phosphate, dioctyl adipate, dibutyl sebacate, and triacetyl glycerol. And the content of the plasticizer is preferably no greater than 60 wt % relative to the total weight of the resin composition for laser engraving, and more preferably no greater than 50 wt %.

### Coloring Agent

Furthermore, a coloring agent such as a dye or pigment may be added for the purpose of coloring the resin composition for laser engraving. The property such as visibility of an image area and compatibility with an image densitometer, can thereby be improved.

The coloring agent is particularly preferably a pigment. Specific examples of the coloring agent include pigments such as phthalocyanine type pigments, azo type pigments, carbon black or titanium oxide, and dyes such as Ethyl Violet, Crystal Violet, azo dyes, anthraquinone type dyes or cyanine dyes.

The amount of the coloring agent is preferably in the range of 0.5 to 10 wt % relative to the total solids content by weight of the resin composition for laser engraving.

### Co-Sensitizer

The sensitivity at the time of photo-curing the resin composition for laser engraving can be further enhanced by using a certain additive (hereinafter referred to as a “co-sensitizer”). The operation mechanism of the co-sensitizer is not clearly known but is considered to be mostly based on the following chemical process. That is, it is presumed that the co-sensitizer reacts with various intermediate active species (radicals and cations) generated in the process of a photo-reaction initiated by the photopolymerization initiator and a subsequent polymerization reaction to produce new active radicals. The co-sensitizers are roughly classified into (i) a compound which is reduced to produce an active radical, (ii) a compound which is oxidized to produce an active radical, and (iii) a compound which reacts with a radical having low activity to convert it into a more highly active radical or acts as a chain transfer agent. However, in many cases, a common view regarding to which type individual compounds belong is not present. Examples of the co-sensitizer that can be used in the present invention include trihalomethyl-s-triazines, trihalomethyloxadiazoles, or diaryliodonium salts, triarylsulfonium salts, N-alkoxypyridinium (azinium) salts, alkylate complexes, alkylamine compounds, α-substituted methylcarbonyl compounds, 2-mercaptobenzothiazoles, 2-mercaptobenzoxazoles, and 2-mercaptobenzimidazoles. More specific examples of the co-sensitizer include those as described in, for example, in JP-A-9-236913 as an additive for improving the sensitivity, and these may also be employed in the present invention.

The co-sensitizers may be used alone or in combination of two or more kinds thereof. The amount of the co-sensitizer used is preferably from 0.05 to 100 parts by weight, more preferably from 1 to 80 parts by weight, and yet more preferably from 3 to 50 parts by weight, relative to 100 parts by weight of the polymerizable compound.

### (Flexo Printing Plate Precursor for Laser Engraving)

A first embodiment of the flexo printing plate precursor for laser engraving in the present invention comprises a relief-forming layer formed from the resin composition for laser engraving of the present invention.

A second embodiment of the flexo printing plate precursor for laser engraving of the present invention comprises a crosslinked relief-forming layer formed by crosslinking a relief-forming layer formed from the resin composition for laser engraving of the present invention.

In the present invention, the ‘flexo printing plate precursor for laser engraving’ means both or one of a plate having a crosslinkable relief-forming layer formed from the resin composition for laser engraving in a state before being crosslinked and a plate in a state in which it is cured by light or heat.

In the present invention, the ‘relief-forming layer’ means a layer in a state before being crosslinked, that is, a layer formed from the resin composition for laser engraving of the present invention, which may be dried as necessary.

The ‘flexo printing plate’ is prepared by laser engraving a printing plate precursor having a crosslinked relief-forming layer.

In the present invention, the ‘crosslinked relief-forming layer’ means a layer formed by crosslinking the relief-forming layer. The crosslinking can be carried out by means of heat and/or light. Furthermore, the crosslinking is not particularly limited as long as it is a reaction by which the resin composition is cured, and example of it includes a structure crosslinked due to reaction between Component C and Component E.

Moreover, in the present invention, the ‘relief layer’ means a layer of the flexo printing plate formed by engraving using a laser, that is, the crosslinked relief-forming layer after laser engraving.

A flexo printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) flexo printing plate precursor for laser engraving may further comprise, as necessary, an adhesive layer between the support and the (crosslinked) relief-forming layer and, above the relief-forming layer, a slip coat layer and a protection film.

### Relief-Forming Layer

The relief-forming layer is a layer formed from the resin composition for laser engraving of the present invention and is preferably a crosslinkable layer by light or heat.

As a mode in which a flexo printing plate is prepared using a flexo printing plate precursor for laser engraving, a mode in which the flexo printing plate is prepared by crosslinking a relief-forming layer by means of light and/or heat to thus form a flexo printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain the flexo printing plate having the relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

### Support

A material having flexibility and excellent dimensional stability is preferably used as the support in the present invention. Preferable examples of the support include a polyethylene terephthalate (PET) film, a polyethylene naphthalate (PEN) film, a polybutylene terephthalate film, and a polycarbonate film. The thickness of the support is from 50 to 350 μm, and preferably from 100 to 250 μm, from the viewpoints of the mechanical characteristics and shape stability of the printing plate precursor, the handling properties during making a printing plate, and the like. Further, if desired, in order to improve the adhesion between the support and the relief-forming resin layer, a known adhesive that has been conventionally used for such a purpose may be provided on the surface of the support.

Further, the adhesion property to the relief-forming resin composition layer or the adhesive layer can be improved by conducting physical or chemical treatment on the surface of the support used in the present invention. Examples of the physical treatment method include a sand blast method, a wet blast method spraying liquid containing particles, a corona discharge treatment method, a plasma treatment method, and an ultraviolet rays or vacuum ultraviolet rays irradiation method. Examples of the chemical treatment method include a treatment method with a strong acid or a strong alkali, a treatment method with an oxidant, and a treatment method with a coupling agent.

### Adhesive Layer

An adhesive layer may be provided between a relief-forming layer and a support for the purpose of strengthening the adhesion between the two.

Examples of materials (adhesives) that can be used in the adhesive layer include those described in ‘Handbook of Adhesives’, Second Edition, Ed by I. Skeist, (1977).

### Protection Film, Slip Coat Layer

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

### (Process for Producing Flexo Printing Plate Precursor for Laser Engraving)

Formation of a relief-forming layer in the flexo printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for producing a flexo printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexo printing plate precursor having a crosslinked relief-forming layer.

In order to mold the flexo printing plate precursor for laser engraving of the present invention into a sheet form or a cylindrical form, the conventional resin-molding methods can be used. For example, a casting method and a method of extruding the resin from a nozzle or dies using a machine, for example, a pump or an extruder and adjusting the thickness by a blade or calendering with rollers are exemplified. In such cases, it is also possible to perform the molding accompanied with heating within a range wherein the performance of the resin composition is not damaged. Also, a rolling treatment, a grinding treatment or the like may be carried out, if desired. Ordinarily, the resin composition is molded on an underlay referred to as a back film composed of a material, for example, PET or nickel in many cases. There is also a case where the resin composition is molded directly on a cylinder of a printing machine. Further, a cylindrical support made of fiber reinforced plastic (FRP), plastic or metal can also be used. As the cylindrical support, a hollow cylindrical support having a constant thickness can be used for the purpose of weight saving. The role of the back film or cylindrical support is to ensure the dimensional stability of the printing plate precursor. Therefore, a material with high dimensional stability should be selected.

Specific examples of the material of the support include a polyester resin, a polyimide resin, a polyamide resin, a polyamideimide resin, a polyetherimide resin, a polybismaleimide resin, a polysulfone resin, a polycarbonate resin, a polyphenyleneether resin, a polyphenylenethioether resin, a polyethersulfone resin, a liquid crystalline resin formed by a full aromatic polyester resin, a full aromatic polyamide resin, and an epoxy resin.

Further, the resins may be used in the form of a laminate. For example, a sheet composed of a full aromatic polyamide film having a thickness of 4.5 μm on both surfaces of which a polyethylene terephthalate layer having a thickness of 50 μm is laminated is exemplified. Moreover, a porous sheet, for example, a cloth formed by knitting of fibers, a nonwoven cloth or a film having fine pores can be used as the back film. In the case of using a porous sheet as the back film, when the relief-forming resin composition is impregnated into the pores of the sheet and then subjected to light curing, a high adhesive property can be achieved by the integration of the cured relief-forming resin layer and the back film.

Examples of the fibers for the formation of cloth or nonwoven cloth include inorganic fibers such as glass fibers, alumina fibers, carbon fibers, alumina-silica fibers, boron fibers, high silicon fibers, potassium titanate fibers and sapphire fibers, natural fibers such as cotton and hemp, semisynthetic fibers such as rayon and acetate, and synthetic fibers such as nylon, polyester, acrylic resin, vinylon, polyvinyl chloride, polyolefin, polyurethane, polyimide and aramide. Furthermore, cellulose produced by a bacterium is a high crystalline nanofiber and is a material capable of making thin nonwoven fibers having high dimensional stability.

The thickness of the relief-forming layer of the printing plate precursor for use in laser engraving can be arbitrarily determined depending on the intended use. When it is used for a printing plate, the thickness is preferably in a range of 0.05 to 10 mm. In view of printing durability of the printing plate and ease of the laser engraving, it is more preferably in a range of 0.1 to 7 mm. Depending on cases, the materials having different compositions may be multiply laminated. The thickness of the relief-forming layer of the flexo printing plate precursor for laser engraving is preferably from 0.0005 to 10 mm, and more preferably from 0.005 to 7 mm.

As a combination of plural layers, for example, it is possible to form a layer capable of undergoing engraving using a laser having an emission wavelength in a near infrared region, for example, a YAG laser, a fiber laser or a semiconductor laser as the uppermost layer, and to form, under the layer, a layer capable of undergoing laser engraving using an infrared laser such as a carbon dioxide laser, or a visible-ultraviolet laser. In the case of conducting the laser engraving by such a method, different laser engraving apparatus equipped with an infrared laser and a near infrared laser respectively can be employed or a laser engraving apparatus equipped with both of an infrared laser and a near infrared laser can also be employed.

### Crosslinking Step

The process for producing a flexo printing plate precursor for laser engraving of the present invention is preferably a production process comprising a crosslinking step of crosslinking a relief-forming layer by means of heat and/or light to thus obtain a flexo printing plate precursor having a crosslinked relief-forming layer, and more preferably a production process comprising a crosslinking step of crosslinking a relief-forming layer by means of heat to thus obtain a flexo printing plate precursor.

The relief-forming layer may be crosslinked by heating the flexo printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

Due to the relief-forming layer being thermally crosslinked, firstly, a relief formed after laser engraving becomes sharp and, secondly, tackiness of engraving residue formed when laser engraving is suppressed.

Furthermore, a photopolymerization initiator, etc. may be used, and in order to polymerize a polymerizable compound to form crosslinking, crosslinking may further be carried out by light.

When a relief-forming layer contains a photopolymerization initiator, the relief-forming layer may be crosslinked by irradiating the relief-forming layer with actinic radiation that functions as a trigger for the photopolymerization initiator.

With regard to irradiation with light, it is usually carried out for the entire surface of the relief-forming layer. Examples of the light (also called ‘actinic radiation’) include visible light, UV light, and an electron beam, and UV light is most commonly used. When a side where a substrate for immobilizing the relief-forming layer such as a support for the relief-forming layer is present is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of a polymerization reaction being inhibited in the presence of oxygen, irradiation with actinic radiation may be carried out after superimposing a vinyl chloride sheet on the relief-forming layer and evacuating.

### Other Layers

According to the present invention, a cushion layer composed of a resin or rubber having cushioning property can be formed between the support and a film made of resin (layer other than the photosensitive layer) or between the film made of resin and the relief-forming resin layer. In the case of forming the cushion layer between the support and the film made of resin, a method of preparing the cushion layer having an adhesive layer on one side and pasting the adhesive layer side thereof onto the cylindrical support is simple and easy manner. After pasting the cushioning layer, the surface thereof may be subjected to cutting and polishing to shape. In a simpler and easier manner, a liquid relief-forming resin composition is coated on the support in a constant thickness and cured with light to from the cushion layer. It is preferable for the cushion layer to have the cushioning property that the hardness of the cured product cured with light is low. The cured relief-forming resin layer having the cushioning property may contain bubbles. It is also possible to subject the surface of the cushion layer to cutting and polishing to shape. The cushion layer thus prepared is useful as a seamless cushion layer.

### (Flexo Printing Plate and Process for Making Same)

The process for making a flexo printing plate of the present invention preferably comprises a layer formation step of forming a relief-forming layer from the resin composition for laser engraving of the present invention, a crosslinking step of crosslinking the relief-forming layer by means of heat and/or light to thus obtain a flexo printing plate precursor having a crosslinked relief-forming layer, and an engraving step of laser-engraving the flexo printing plate precursor having the crosslinked relief-forming layer.

The flexo printing plate of the present invention is a flexo printing plate having a relief layer obtained by crosslinking and laser-engraving a layer formed from the resin composition for laser engraving of the present invention, and is preferably a flexo printing plate made by the process for making a flexo printing plate of the present invention.

The layer formation step and the crosslinking step in the process for making a flexo printing plate of the present invention mean the same as the layer formation step and the crosslinking step in the above-mentioned process for producing a flexo printing plate precursor for laser engraving, and preferred ranges are also the same.

### Conditions for Laser Engraving

In the laser engraving, a relief image is prepared on the printing plate precursor by making digitalized data based on the image to be formed and operating a laser device based on the digitalized data utilizing a computer.

The laser used in the laser engraving can be any laser as long as it contains a wavelength at which the printing plate precursor has absorption. In order to carry out the engraving with high speed, a laser having a high power is desirable. One preferable example of the laser is a laser having an emitting wavelength in an infrared region or near infrared region, such as a carbon dioxide laser, a YAG laser, a semiconductor laser, and a fiber laser. Further, an ultraviolet laser having an emitting wavelength in an ultraviolet region, for example, an excimer laser, a YAG laser wavelength-converted to the third harmonic or the fourth harmonic, or a copper vapor laser is able to conduct ablation processing which cleaves a bond between organic molecules and thus is suitable for microfabrication. A laser having an extremely high peak power, such as a femtosecond laser, can also be employed. The laser irradiation may be performed continuously or pulsewise.

Although the engraving with a laser is conducted under oxygen-containing gas, ordinarily in the presence of air or in an airflow, it can be conducted under carbon dioxide gas or nitrogen gas. After the completion of the engraving, the flexo printing plate may be subjected to a washing step (rinsing step) for removal of the powdery or liquid substance occurring to a slight extent on the surface of the flexo printing plate using an appropriate method, for example, a method of washing out, for example, with a solvent or water containing a surfactant, a method of spraying an aqueous cleaning agent, for example, by a high-pressure sprayer, or a method of spraying high-pressure steam.

The flexo printing plate precursor for laser engraving or flexo printing plate of the present invention can be applied to various usages, such as a stamp, a seal, a design roll for embossing, a relief image for patterning an insulator, resistor or conductive paste used for the production of electronic components, a relief image for a mold material of ceramic products, a relief image for display, such as an advertising board or a sign board, or a prototype or matrix of various moldings, as well as the relief image for a printing plate.

Surface Treatment after Laser Engraving

A decrease in tackiness on the surface of the printing plate or improved ink wetting properties is also achieved by forming a modifying layer on the surface of the relief of the cylindrical printing plate having the concavo-convex pattern according to the present invention. As the modifying layer, a coating film layer treated with a compound reacting with hydroxy group on the surface of the layer, such as a silane coupling agent and a titanium coupling agent, or a layer of a polymer film containing porous inorganic particles is exemplified. The silane coupling agent widely used is a compound having a functional group in its molecule, which has high reactivity with hydroxy group on the surface of a base material. Examples of the functional group include a trimethoxysilyl group, a triethoxysilyl group, a trichlorosilyl group, a diethoxysilyl group, a dimethoxysilyl group, a dichlorosilyl group, a monoethoxysilyl group, a monomethoxysilyl group, and a monochlorosilyl group. Further, at least one of the functional groups is present in the molecule and the compound is fixed on the surface of the substrate by the reaction of the functional group with hydroxy group on the surface of the substrate. Further, as the compound constituting the silane coupling agent, the compound having at least one functional group selected from the group consisting of an acryloyl group, a methacryloyl group, an active halogen-containing amino group, an epoxy group, a vinyl group, a perfluoroalkyl group, and a mercapto group or the compound having a long chain alkyl group can be used. When the molecule of the coupling agent fixed on the surface particularly has a polymerizable reactive group, the more solid coating film can be formed by irradiating the surface with light, heat or an electron beam after the fixing on the surface to form crosslinkage.

A surface treating solution is prepared by diluting the above-described coupling agent with a mixed solution of water and an alcohol or of aqueous acetic acid and an alcohol, as the need arises. The concentration of the coupling agent in the treating solution is preferably from 0.05 to 10.0 wt %.

A method of treatment with the coupling agent is described below. The treating solution containing the coupling agent is used by coating on the surface of the printing plate precursor or the surface of the printing plate after the laser engraving. The method for coating the treating solution of the coupling agent is not particularly restricted and, for example, a dip coating method, a spray coating method, a roll coating method, or a brush coating method can be appropriately used. Further, although the coating treatment temperature and coating treatment time are also not particularly limited, the treatment temperature is preferably from 5 to 60° C. and the treatment time is preferably from 0.1 to 60 seconds. The drying of the treatment solution layer on the surface of the printing plate is preferably carried out with heating and the heating temperature is preferably from 50 to 150° C.

As the method of treatment with the coupling agent, can be employed a method in which by irradiating the surface of the printing plate with light of a vacuum ultraviolet region having a wavelength of 200 nm or less, such as with a xenon excimer lamp or exposing the surface of the printing plate to a high energy atmosphere, such as a plasma, prior to the treatment of the surface of the printing plate with the coupling agent, hydroxy groups are generated on the surface of the printing plate and the coupling agent is fixed at a high density.

Further, when the layer containing the inorganic porous particles is revealed on the surface of the printing plate, by treating the surface under a high energy atmosphere, for example, a plasma, to somewhat remove the organic substance layer of the surface by etching, fine concavities and convexities can be formed on the surface of the printing plate. According to the treatment, the effects of decrease in tackiness on the surface of the printing plate and improvement in ink wetting properties due to ease of ink absorption of the inorganic porous particles revealed on the surface can be expected.

The process for making a flexo printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and especially preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a flexo printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

According to the present invention, a resin composition for laser engraving, that can be used to prepare an excellent printing plate precursor having high engraving sensitivity as well as excellent rinsing properties and dust-collecting properties; a flexo printing plate precursor for laser engraving using the resin composition, and a process for producing the same; a process for making a flexo printing plate using the printing plate precursor; and a flexo printing plate can be provided.

### EXAMPLES

Hereinbelow, the present invention will be described in detail with reference to Examples, but the present invention is not limited to these Examples.

Furthermore, the parts of the addition amount in Examples represent parts by weight.

The compounds of Component A to Component F used in the present Examples and Comparative Examples are shown below.

A-1: Methyl polymethacrylate-based particles SSX-101 (manufactured by Sekisui Chemical Co., Ltd.)
A-2: Methyl polymethacrylate-based particles SSX-110 (manufactured by Sekisui Chemical Co., Ltd.)
A-3: Porous polyacrylic acid ester-based particles ACX-807C (manufactured by Sekisui Chemical Co., Ltd.)
A-4: Dimethyl polysiloxane-based particles KMP-597 (manufactured by Shin-Etsu Chemical Co., Ltd.)
A-5: Colorless acrylic resin-based particles AR650S (manufactured by Toyou Spinning Co., Ltd.)
A-6: Colored (black) acrylic resin-based particles AR650S (manufactured by Toyou Spinning Co., Ltd.)
A-7: Ethylene-vinyl acetate copolymer Flowback (manufactured by Sumitomo Chemical Co., Ltd.)
A-8: Methyl polymethacrylate-based particles MBX-50 (manufactured by Sekisui Chemical Co., Ltd.)
A-9: Acryllic resin-based polymerized product (organic fine particles (D-1) described in paragraphs 0133 to 0134 of JP-A-2011-31501)
A-10: Polyimide-based particles UIP-R (manufactured by Ube Industries, Ltd.)
A-11: Acrylic resin-based polymerized product (organic fine particles (D-3) described in paragraph 0321 of JP-A-2008-136051)
B-1: Carbon black Asahi #80 N-220 (manufactured by Asahi Carbon Co., Ltd.)
B-2: Iron oxide-based pigment Bengala No. 211 (manufactured by Daito Kasei Kogyo Co., Ltd.)
B-3: Cerium oxide/aluminum hydroxide-containing silica-based pigment CERIGUARD S-3018-02 (manufactured by Daito Kasei Kogyo Co., Ltd.)
B-4: Carbon (manufactured by SIGMA-ALDRICH)
B-5: Carbon black (manufactured by SIGMA-ALDRICH)
B-6: Alumina particles AL-160SG-3 (manufactured by Showa Dekiko K. K.)
B-7: Silica-based particles Tospearl 130 (manufactured by Toshiba Silicone Co., Ltd.)
C-1: Polyvinylbutyral S-LEC BL-1 (manufactured by Sekisui Chemical Co., Ltd.)
C-2: Styrene-butadiene copolymer TR2000 (manufactured by JSR Co., Ltd.)
C-3: Styrene-isoprene copolymer D-1161 (manufactured by JSR Co., Ltd.)
D-1: Diethylene glycol dimethacrylate (manufactured by Shin-Nakamura Chemical Co., Ltd.)
D-2: Dipentaerythritol hexaacrylate (DPHA) (manufactured by Shin-Nakamura Chemical Co., Ltd.)
D-3: Tricyclodecanedimethanol dimethacrylate (DCP) (manufactured by Shin-Nakamura Chemical Co., Ltd.)
E-1: Bis(triethoxysilylpropyl) tetrasulfide (KBE-846, manufactured by Shin-Etsu Chemical Co., Ltd.)
E-2: Tris(3-trimethoxysilylpropyl) isocyanurate (X-12-965, manufactured by Shin-Etsu Chemical Co., Ltd.)
E-3: 3-Methacryloxypropyltriethoxysilane (KBE-503, manufactured by Shin-Etsu Chemical Co., Ltd.)
F-1: Phosphoric acid (manufactured by Wako Pure Chemical Industries, Ltd.)
F-2: Methanesulfonic acid (manufactured by Wako Pure Chemical Industries, Ltd.)
F-3: 1,8-Diazabicyclo[5.4.0]undeca-7-ene (manufactured by Wako Pure Chemical Industries, Ltd.)

Furthermore, the spectral absorption of Component A (colorless resin particles) was measured by the following method to confirm that there was no maximum absorption in the wavelength region of 400 to 700 nm.

Material preparation method: Colorless resin particles were dissolved in dimethylacetamide, poured into a Teflon dish, and put into and dried in an oven at 100° C. for 20 hours, thereby preparing a film having a thickness of about 100 μm.

Measurement method: Using an ultraviolet-visible spectrophotometer V-7100 manufactured by JASCO Corporation, the absorbance was measured in the wavelength range of 185 to 900 nm.

### Preparation of Relief-Forming Layer Coating Liquid (Resin Composition for Laser Engraving) of Examples 1 to 26

A three-necked flask equipped with a stirring blade and a cooling tube was charged with 40 parts by weight of (Component C) a binder polymer described in Tables 1 and 2 below, 20 parts by weight of diethylene glycol as a plasticizer, and 150 parts by weight of tetrahydrofuran as a solvent, and the mixture was heated to 70° C. for 120 minutes under stirring. Further, a binder was dissolved therein. To this binder dispersion were added 20 parts by weight of (Component D) a polymerizable compound described in Table 1 below, 0.005 parts by weight of PERBUTYL Z (t-butylperoxybenzoate) (manufactured by NOF Corp.) as a polymerization initiator, 18 parts by weight of (Component E) a compound described in Table 1 below, and 0.5 parts by weight of (Component F) a catalyst described in Table 1 below, and in addition, 2 parts by weight of (Component A) colorless resin particles described in Table 1 below and 4 parts by weight of (Component B) a photothermal conversion agent described in Table 1 below were added thereto, and the mixture was subjected to a dispersion treatment to obtain a coating liquid composition for a flexo printing plate precursor for laser engraving of Example 1 (resin composition for laser engraving). In the same manner as below, the resin compositions for laser engraving of Examples 2 to 26, including the components and having the addition amounts, each described in Tables 1 and 2, were prepared.

### Preparation of Flexo Printing Plate Precursors for Laser Engraving and Flexo Printing Plates of Examples 1 to 26

A spacer (frame) having a predetermined thickness was provided on a PET substrate, and the resin composition for laser engraving for a printing plate precursor as described above was carefully cast thereinto to such an extent to not flow out of the spacer (frame) and dried in an oven at 70° C. for 3 hours to remove the solvent, thereby preparing a flexo printing plate precursor for laser engraving having a relief-forming layer with a thickness of about 1 mm. The obtained relief-forming layer of the flexo printing plate precursor was subjected to thermal crosslinking by heating at 100° C. for 2.5 hours and then to laser engraving to form a relief layer, thereby preparing a flexo printing plate of each of Examples 1 to 26 from the resin composition for laser engraving of Examples 1 to 26.

### Preparation of Comparative Examples 1 to 17

### Comparative Example 1

By carrying out the same procedure except that the (Component A) colorless resin particles and the (Component B) photothermal conversion agent were not added in Example 1, Comparative Example 1 was prepared. The addition amounts and the volume-average particle diameters are shown in Table 2 (the addition amounts and the volume-average particle diameters of Comparative Examples below are also shown in Table 2).

### Comparative Example 2

By carrying out the same procedure except that (Component B) a photothermal conversion agent was not added in Example 1, Comparative Example 2 was prepared.

### Comparative Example 3

By carrying out the same procedure except that (Component A) colorless resin particles were not added in Example 1, Comparative Example 3 was prepared.

### Comparative Example 4

By carrying out the same procedure except that (Component C) a binder polymer was not added in Example 1, Comparative Example 4 was prepared.

### Comparative Example 5

By carrying out the same procedure except that the content of (Component B) a photothermal conversion agent was changed to 0.5 wt % in Example 14, Comparative Example 5 was prepared.

### Comparative Example 6

By carrying out the same procedure except that (Component B) a photothermal conversion agent was replaced with alumina particles AL-160SG-3 (Compound B-6, manufactured by Showa Denko K. K.) in Example 1, Comparative Example 6 was prepared.

### Comparative Example 7

By carrying out the same procedure except that (Component B) a photothermal conversion agent was replaced with silica-based particles Tospearl 130 (Compound B-7, manufactured by Toshiba Silicone Co., Ltd.), Comparative Example 7 was prepared.

### Comparative Examples 8 to 10

By carrying out the same procedure except that (Component A) colorless resin particles was replaced with colored (black) acrylic resin-based particles AR650S (Compound A-6, manufactured by TOYOBO Co., Ltd.) in Example 10, Comparative Example 8 was prepared.

By carrying out the same replacement, Comparative Example 9 was prepared from Example 11 and Comparative Example 10 was prepared from Example 12.

### Comparative Example 11

By carrying out the same procedure except that (Component A) colorless resin particles were replaced with an ethylene-vinyl acetate copolymer Flowback (Compound A-7, manufactured by SUMITOMO SEIKA CHEMICALS Co., Ltd.) in Example 1, Comparative Example 11 was prepared.

### Comparative Example 12

By carrying out the same procedure except that (Component A) colorless resin particles were replaced with methyl polymethacrylate-based particles MBX-50 (Compound A-8, manufactured by SEKISUI PLASTICS Co., Ltd.) in Example 1, Comparative Example 12 was prepared.

### Comparative Example 13

By carrying out the same procedure except that (Component B) a photothermal conversion agent was changed to 2 wt % of carbon black having a particle diameter of 43 μm (Compound B-5, manufactured by SIGMA-ALDRICH) in Example 14, Comparative Example 13 was prepared.

### Comparative Example 14

By carrying out the same procedure except that (Component A) colorless resin particles was replaced with an acrylic resin-based polymerized product (Compound A-9, organic fine particles (D-1) described in paragraphs 0133 to 0134 of JP-A-2011-31501) in Example 14, Comparative Example 14 was prepared.

### Comparative Example 15

By carrying out the same procedure except that (Component A) colorless resin particles were replaced with an acrylic resin-based polymerized product (Compound A-11, organic fine particles (D-3) described in paragraph 0321 of JP-A-2008-13605) in Example 14, Comparative Example 15 was prepared.

### Comparative Example 16

By carrying out the same procedure except that the content of (Component A) colorless resin particles was changed to 30 wt % in Example 14, Comparative Example 16 was prepared.

### Comparative Example 17

By carrying out the same procedure except that the content of (Component B) a photothermal conversion agent was changed to 18 wt % in Example 14, Comparative Example 17 was prepared.

### Comparative Example 18

By carrying out the same procedure except that (Component A) colorless resin particles was replaced with polyimide-based particles UIP-R (Compound A-10, manufactured by Ube Industries, Ltd.) in Example 14, Comparative Example 18 was prepared.

### Comparative Example 19

By carrying out the same procedure except that (Component B) a photothermal conversion agent was not added in Comparative Example 16, Comparative Example 19 was prepared.

### Measurement of Thermophysical Properties

Under the following conditions, 20% weight-reduction temperatures of the colorless resin particles used in Examples and Comparative Examples were measured.

Equipment: Thermogravimetric measuring apparatus (manufactured by TA Instruments Japan Co., Ltd.)

Measurement conditions: 10 mg of a sample was weighed from each of the compositions as prepared above, and heated from 30° C. to 800° C. at a temperature elevation rate of 5° C./minute under an inert gas atmosphere.

### Measurement of Engraving Sensitivity

As a near-infrared laser engraving machine, “FD-100” equipped with a semiconductor laser (at a wavelength for laser oscillation of 840 nm) (manufactured by TOSEI ELECTOROBEAM Co., Ltd.) having a maximum output power of 16 W was used. For the flexo printing plate precursor for laser engraving of Examples 1 to 26 and Comparative Examples 1 to 17, the engraving conditions were set such that the laser output power was 15 W, the scanning speed was 100 mm/second, and the pitch spacing was 0.15 mm, to engrave a 2-cm square solid part, thereby preparing a flexo printing plate.

The engraving depth is a numerical value of the engraving sensitivity obtained from the measured value by observing the cross-section of the solid engraved part with an ultra-deep color 3D profile measuring microscope VK9510 (manufactured by Keyence Corporation), and measuring the difference between the surface of the engraved side and the depth of the engraved part, and is shown in Table 3 (the measurements below are also shown in Table 3). The engraving sensitivity is at a level, at which 250 μm or more is acceptable for the numerical value.

### Measurement of Rinsing Properties

Since the measurement error of the rinsing properties due to the engraving sensitivity of each printing plate is lost, engraving was carried out with a carbon dioxide gas laser engraving machine. A “CO₂ laser marker ML-Z9500” (manufactured by Keyence Corporation) equipped with a carbon dioxide laser having a maximum output power of 30 W was used. For the flexo printing plate precursor for laser engraving of Examples 1 to 26 and Comparative Examples 1 to 17, the engraving conditions were set such that the laser output power was 15 W, the scanning speed was 100 mm/second, and the pitch spacing was 0.15 mm, to engrave a 2-cm square solid part, thereby preparing a flexo printing plate.

For the sample immediately after the laser engraving, the engraving surface was not subjected to an operation such as physical rubbing and the water droplets adhered to the surface after washing with tap water at a constant rate for 1 minute were removed by wiping with KIMUWAIPU™ (manufactured by NIPPON PAPER CRECIA Co., Ltd.), and the obtained engraving surface was observed by means of SEM (electronic scanning electron microscope; JSM-7401 manufactured by JEOL Ltd.) to check the presence or absence of the engraving residue remaining on the engraving portion.

Excellent: The engraving residue is in a powder form and provides a clear concave-convex pattern.

Fine: The engraving residue is in a paste form with high viscosity and provides a clear concave-convex pattern.

Good: The engraving residue is in a paste form with low viscosity and its concave-convex pattern can be determined.

Good/Poor: The engraving residue is in a paste form with low viscosity, but does not have a clear concave-convex pattern.

Poor: The engraving residue is in a liquid form and does not have a clear concave-convex pattern.

Levels denoted as Excellent, Fine, and Good are acceptable.

### Measurement of Dust Collecting Properties

For the flexo printing plate precursors for laser engraving of Examples 1 to 26 and Comparative Examples 1 to 17, engraving was carried out with a carbon dioxide laser engraving machine. During the laser irradiation, suction was carried out with a dust-collecting machine provided near the laser device, and the state of the engraving residue adhered to the suction opening part was examined. As the carbon dioxide laser engraving machine, a “HELIOS 6010” (manufactured by Stork Prints BV) was used (the dust-collecting machine was an accessory part). The engraving conditions were set such that the laser output power was 500 W, the drum rotation rate was 800 cm/second, and the relief depth was 0.30 mm, to engrave a 4-cm square solid part. Further, the suction opening was provided above the laser irradiation part.

Excellent: The engraving residue is in a powder form, and is easily detached even by simply tapping the suction opening lightly.

Fine: The engraving residue is in a paste form with high viscosity and is easily peeled off by a manual operation.

Good: The engraving residue is in a paste form with relatively low viscosity and is detached from the suction opening even by rubbing with a towel.

Good/Poor: The engraving residue is in a paste form with low viscosity and cannot be detached without the use of chemicals.

Poor: The engraving residue is in a paste form with low viscosity, but cannot be easily detached even with the use of chemicals.

Levels denoted as Excellent, Fine, and Good are acceptable.

TABLE 1

| | Compound | | | | | | |
|---|---|---|---|---|---|---|---|
| | | | | | | | 20% weight- |
| | | | | | | | reduction |
| | Colorless | | | | | | temperature |
| | resin | Photothermal | Binder | Polymerizable | | | of colorless |
| | particles | conversion | polymer | compound | Compound | Catalyst | resin particles |
| | (A) | agent (B) | (C) | (D) | (E) | (F) | (A)/° C. |
| Example No. | | | | | | | |
| 1 | A-1 | B-1 | C-1 | D-1 | E-1 | F-1 | 320 |
| 2 | A-1 | B-1 | C-1 | None | None | None | 320 |
| 3 | A-1 | B-1 | C-1 | D-1 | E-1 | F-1 | 320 |
| 4 | A-2 | B-1 | C-1 | D-1 | E-1 | F-1 | 320 |
| 5 | A-2 | B-1 | C-1 | D-1 | E-1 | F-1 | 320 |
| 6 | A-3 | B-1 | C-1 | D-1 | E-1 | F-1 | 310 |
| 7 | A-4 | B-1 | C-1 | D-1 | E-1 | F-1 | 400 |
| 8 | A-4 | B-2 | C-1 | D-1 | E-1 | F-1 | 400 |
| 9 | A-5 | B-1 | C-1 | D-2 | E-2 | F-1 | 300 |
| 10 | A-5 | B-1 | C-1 | D-1 | E-1 | F-1 | 300 |
| 11 | A-5 | B-1 | C-2 | D-2 | E-2 | F-1 | 300 |
| 12 | A-5 | B-1 | C-3 | D-3 | E-2 | F-1 | 300 |
| 13 | A-1 | B-3 | C-1 | D-2 | E-1 | F-2 | 320 |
| 14 | A-1 | B-1 | C-1 | D-1 | E-1 | F-1 | 320 |
| 15 | A-1 | B-4 | C-1 | D-3 | E-1 | F-2 | 320 |
| 16 | A-1 | B-1 | C-2 | D-1 | E-1 | F-1 | 320 |
| 17 | A-1 | B-1 | C-1 | D-1 | E-1 | F-1 | 320 |
| 18 | A-1 | B-4 | C-3 | D-2 | E-3 | F-3 | 320 |
| 19 | A-1 | B-1 | C-1 | D-1 | E-1 | F-1 | 320 |
| 20 | A-1 | B-1 | C-1 | D-1 | E-1 | F-1 | 320 |
| 21 | A-1 | B-1 | C-1 | D-1 | E-1 | F-1 | 320 |
| 22 | A-2 | B-1 | C-1 | D-1 | E-1 | F-1 | 320 |
| 23 | A-1 | B-4 | C-1 | D-1 | E-1 | F-1 | 320 |
| 24 | A-1 | B-1 | C-1 | D-1 | E-1 | F-1 | 320 |
| 25 | A-1 | B-1 | C-1 | D-1 | E-1 | F-1 | 320 |
| 26 | A-2 | B-1 | C-1 | D-1 | None | F-1 | 320 |
| Comparative | | | | | | | |
| Example No. | | | | | | | |
| 1 | None | None | C-1 | D-1 | E-1 | F-1 | — |
| 2 | A-1 | None | C-1 | D-1 | E-1 | F-1 | 320 |
| 3 | None | B-1 | C-1 | D-1 | E-1 | F-1 | — |
| 4 | A-1 | B-1 | None | D-1 | E-1 | F-1 | 320 |
| 5 | A-1 | B-6 | C-1 | D-1 | E-1 | F-1 | 320 |
| 6 | A-1 | B-7 | C-1 | D-1 | E-1 | F-1 | 320 |
| 7 | A-6 | B-1 | C-1 | D-1 | E-1 | F-1 | 300 |
| 8 | A-6 | B-1 | C-2 | D-2 | E-2 | F-1 | 300 |
| 9 | A-6 | B-1 | C-3 | D-3 | E-2 | F-1 | 300 |
| 10 | A-7 | B-1 | C-1 | D-1 | E-1 | F-1 | 430 |
| 11 | A-8 | B-1 | C-1 | D-1 | E-1 | F-1 | 320 |
| 12 | A-1 | B-5 | C-1 | D-1 | E-1 | F-1 | 320 |
| 13 | A-9 | B-1 | C-1 | D-1 | E-1 | F-1 | 280 |
| 14 | A-1 | B-1 | C-1 | D-1 | E-1 | F-1 | 320 |
| 15 | A-1 | B-1 | C-1 | D-1 | E-1 | F-1 | 320 |
| 16 | A-10 | B-1 | C-1 | D-1 | E-1 | F-1 | 630 |
| 17 | A-10 | None | C-1 | D-1 | E-1 | F-1 | 630 |

TABLE 2

| | Volume- average particle | | | | |
|---|---|---|---|---|---|
| | diameter (μm) | | Content (wt %) | | |
| | Colorless | Photo- | Colorless | Photo- | |
| | resin | thermal | resin | thermal | Binder |
| | particles | conversion | particles | conversion | polymer |
| | (A) | agent (B) | (A) | agent (B) | (C) |
| Example No. | | | | | |
| 1 | 1 | 0.2 | 2 | 4 | 40 |
| 2 | 1 | 0.2 | 2 | 4 | 40 |
| 3 | 1 | 0.2 | 10 | 4 | 40 |
| 4 | 10 | 0.2 | 2 | 4 | 40 |
| 5 | 10 | 0.2 | 10 | 4 | 40 |
| 6 | 8 | 0.2 | 2 | 4 | 40 |
| 7 | 5 | 0.2 | 2 | 4 | 40 |
| 8 | 5 | 0.5 | 2 | 4 | 40 |
| 9 | 18 | 0.2 | 2 | 4 | 40 |
| 10 | 18 | 0.2 | 23 | 4 | 40 |
| 11 | 18 | 0.2 | 23 | 4 | 40 |
| 12 | 18 | 0.2 | 23 | 4 | 40 |
| 13 | 1 | 0.5 | 4 | 2 | 40 |
| 14 | 1 | 0.2 | 2 | 2 | 40 |
| 15 | 1 | 7 | 2 | 8 | 40 |
| 16 | 1 | 0.2 | 2 | 2 | 40 |
| 17 | 1 | 0.2 | 2 | 8 | 40 |
| 18 | 1 | 7 | 2 | 8 | 40 |
| 19 | 1 | 0.2 | 10 | 2 | 40 |
| 20 | 1 | 0.2 | 4 | 2 | 40 |
| 21 | 1 | 0.2 | 23 | 2 | 40 |
| 22 | 10 | 0.2 | 2 | 2 | 40 |
| 23 | 1 | 7 | 2 | 2 | 40 |
| 24 | 1 | 0.2 | 2 | 4 | 70 |
| 25 | 1 | 0.2 | 2 | 4 | 10 |
| 26 | 10 | 0.2 | 10 | 4 | 40 |
| Comparative | | | | | |
| Example No. | | | | | |
| 1 | — | — | — | — | 40 |
| 2 | 1 | — | 2 | — | 40 |
| 3 | — | 0.2 | — | 4 | 40 |
| 4 | 18 | 0.2 | 2 | 4 | — |
| 5 | 1 | 0.5 | 2 | 4 | 40 |
| 6 | 1 | 3 | 2 | 4 | 40 |
| 7 | 18 | 0.2 | 23 | 4 | 40 |
| 8 | 18 | 0.2 | 23 | 4 | 40 |
| 9 | 18 | 0.2 | 23 | 4 | 40 |
| 10 | 200 | 0.2 | 2 | 2 | 40 |
| 11 | 50 | 0.2 | 2 | 2 | 40 |
| 12 | 1 | 43 | 2 | 2 | 40 |
| 13 | 0.07 | 0.2 | 2 | 2 | 40 |
| 14 | 1 | 0.2 | 30 | 2 | 40 |
| 15 | 1 | 0.2 | 2 | 18 | 40 |
| 16 | 12.5 | 0.2 | 2 | 2 | 40 |
| 17 | 12.5 | — | 2 | — | 40 |

TABLE 3

| | Performance | | |
|---|---|---|---|
| | Sensitivity | Rinsing properties | Dust-collecting |
| | (μm) | Fine/Excellent/Good/Poor | properties |
| Example No. | | | |
| 1 | 360 | Fine | Excellent |
| 2 | 380 | Good | Fine |
| 3 | 310 | Excellent | Fine |
| 4 | 360 | Fine | Excellent |
| 5 | 310 | Excellent | Fine |
| 6 | 360 | Fine | Excellent |
| 7 | 360 | Fine | Excellent |
| 8 | 330 | Fine | Fine |
| 9 | 360 | Fine | Excellent |
| 10 | 270 | Excellent | Good |
| 11 | 250 | Excellent | Good |
| 12 | 255 | Excellent | Good |
| 13 | 360 | Fine | Good |
| 14 | 400 | Fine | Fine |
| 15 | 285 | Fine | Excellent |
| 16 | 370 | Fine | Good |
| 17 | 300 | Fine | Excellent |
| 18 | 270 | Fine | Excellent |
| 19 | 330 | Excellent | Good |
| 20 | 370 | Fine | Good |
| 21 | 280 | Excellent | Good |
| 22 | 380 | Fine | Good |
| 23 | 390 | Fine | Good |
| 24 | 380 | Good | Excellent |
| 25 | 340 | Fine | Excellent |
| 26 | 310 | Good | Fine |
| Comparative | | | |
| Example No. | | | |
| 1 | 0 (Not | Poor | Poor |
| | engraved) | | |
| 2 | 0 (Not | Good | Poor |
| | engraved) | | |
| 3 | 375 | Good Poor | Poor |
| 4 | 235 | Good | Fine |
| 5 | 0 (Not | Fine | Fine |
| | engraved) | | |
| 6 | 0 (Not | Fine | Fine |
| | engraved) | | |
| 7 | 200 | Excellent | Good |
| 8 | 180 | Excellent | Good |
| 9 | 185 | Excellent | Poor |
| 10 | 310 | Good | Poor |
| 11 | 325 | Good | Poor |
| 12 | 370 | Good | Good Poor |
| 13 | 410 | Fine | Poor |
| 14 | 250 | Excellent | Good Poor |
| 15 | 230 | Excellent | Fine |
| 16 | 235 | Fine | Fine |
| 17 | 0 (Not | Fine | Fine |
| | engraved) | | |

From the results of Table 3, there can be seen a tendency that when the 20% weight-reduction temperature of the added colorless resin particles is higher, the rinsing properties and the dust-collecting properties are improved, and further, the engraving sensitivity is relatively lowered. Since the colorless resin particles having excellent heat resistance have a high glass transition temperature and the particles themselves have high hardness, the addition of such colorless resin particles causes the mechanical and physical properties of the film to be enhanced and the engraving residue to have high viscosity, thereby greatly improving the rinsing properties and the dust-collecting properties. On the contrary, it is thought that since the colorless resin particles are not easily thermally decomposed, there is a tendency that the engraving sensitivity is lowered.

The flexo printing plate precursor of the present invention makes it possible to prepare a flexo printing plate precursor for laser engraving having excellent engraving sensitivity, rinsing properties, and dust-collecting properties, as compared with the printing plate precursors of 1) Comparative Examples, in which the colorless resin particles and the photothermal conversion agent were not added, 2) Comparative Examples, in which only the photothermal conversion agent was not added, or 3) Comparative Examples, in which only the colorless resin particles were not added, by controlling the content or the particle size of such additives.

In addition, the relief layer of the printing plate precursor using the colored resin particles (Comparative Example 8) exhibits equivalent performance in view of the rinsing properties and the dust-collecting properties, as compared to the relief layer of the printing plate precursor using the colorless resin particles having the same material and shape as the resin particles (Example 10), but there was a tendency that the engraving sensitivity was decreased, as compared with the colorless resin particles. This is thought to be caused by the addition of the colored resin particles which results in decrease in the engraving sensitivity without the penetration of laser light into the flexo printing plate.

With regard to the dust-collecting properties, it was found that a printing plate precursor formed having a combination of colorless resin particles and a photothermal conversion agent has excellent dust-collecting properties, as compared with the printing plate precursor not having such combination. These results are an unexpected improvement of the performance, the reason for which is not still clarified. For the printing plate precursor having a combination of colorless resin particles and a photothermal conversion agent, the dispersing properties of carbon black were examined, and as a result, it could be seen that there is a tendency for the photothermal conversion agent to be adsorbed on the surface of the colorless resin particles. From the difference of the surface energy of the respective materials, it is thought that the photothermal conversion agent gathers in the vicinity of the colorless resin particles. Since the molten product of the colorless resin particle, that is caused by engraving with laser light, is surrounded by much carbon black, the compositional distribution of the engraving residue is different from those in Comparative Examples of 2) and 3) above, and it is thought that such difference causes the microstructure of the residue to be porous or the difference in the surface energy causes, for example, generation of the engraving residue having high dust-collecting properties.

From the above, it is understood that according to the present invention, a resin composition for laser engraving, a flexo printing plate precursor for laser engraving, and a flexo printing plate, each of which has excellent engraving sensitivity, rinsing properties, and dust-collecting properties, can be provided.

What is claimed is:

1. A resin composition comprising:
1 to 25 wt % of (Component A) colorless resin particles having a volume-average particle diameter of 0.2 to 30 μm;
1 to 15 wt % of (Component B) a photothermal conversion agent capable of absorbing light having a wavelength of 700 to 1,300 nm; and
2 to 95 wt % of (Component C) a binder polymer,
wherein the 20% weight-reduction temperature of Component A in thermogravimetric analysis under an inert gas atmosphere is from 200 to 600° C.

2. The resin composition according to claim 1, wherein the volume-average particle diameter of Component B is from 0.001 to 10 μm.

3. The resin composition according to claim 1, wherein Component B is carbon black.

4. The resin composition according to claim 1, wherein Component A is at least one type of colorless resin particles selected from the group consisting of methyl polymethacrylate particles, porous polyacrylic acid ester particles, dimethyl polysiloxane particles, polyimide particles, and ethylene-vinyl acetate copolymer particles.

5. The resin composition according to claim 1, wherein Component A is at least one type of colorless resin particles selected from the group consisting of methyl polymethacrylate particles, porous polyacrylic acid ester particles, and dimethyl polysiloxane particles.

6. The resin composition according to claim 1, wherein the resin composition further comprises (Component D) a polymerizable compound.

7. The resin composition according to claim 6, wherein the polymerizable compound has two or more ethylenically unsaturated bonds.

8. The resin composition according to claim 1, wherein the resin composition further comprises (Component E) a compound having at least one of a hydrolyzable silyl group and/or silanol groups.

9. The resin composition according to claim 1, wherein the resin composition further comprises (Component F) an alcohol exchange reaction catalyst.

10. The resin composition according to claim 1, wherein the 20% weight-reduction temperature of Component A in thermogravimetric analysis under an inert gas atmosphere is from 300 to 400° C.

11. A flexo printing plate precursor having a relief-forming layer formed from the resin composition according to claim 1.

12. A flexo printing plate precursor having a crosslinked relief-forming layer formed by crosslinking the relief-forming layer formed with the resin composition according to claim 1 by light and/or heat.

13. The flexo printing plate precursor according to claim 11, wherein the thickness of the relief-forming layer is 0.05 mm or more and 10 mm or less.

14. A process for producing a flexo printing plate precursor, comprising:
a layer forming step of forming a relief-forming layer comprising the resin composition according to claim 1; and
a crosslinking step of crosslinking the relief-forming layer by heat and/or light to obtain a flexo printing plate precursor having a crosslinked relief-forming layer.

15. A process for making a flexo printing plate, comprising an engraving step of subjecting the flexo printing plate precursor having a crosslinked relief-forming layer according to claim 12 to laser engraving to form a relief layer.

16. The process for making a flexo printing plate according to claim 15, wherein the laser engraving is carried out by means of a semiconductor laser.

17. The process for making a flexo printing plate according to claim 15, further comprising a washing step of washing the surface of the relief layer after the engraving step with water or an aqueous solution.

18. A flexo printing plate having a relief layer produced by the process for making a flexo printing plate according to claim 15.
